(19) United States
(12) Patent Application Publication
(10) Pub. No.: US 2005/0260518 A1
(43) Pub. Date: Nov. 24, 2005

(54) Heat sensitive recording material and microcapsule

(75) Inventors: Hisahiro Mori, Shizuoka-ken (JP); Yoshihiro Jimbo, Shizuoka-ken (JP); Hisato Nagase, Shizuoka-ken (JP); Toshihide Aoshima, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/132,340

(22) Filed: May 19, 2005

(30) Foreign Application Priority Data
May 19, 2004 (JP) 2004-149816
May 19, 2004 (JP) 2004-149819

(51) Int. Cl. G03C 5/18

(52) U.S. Cl. 430/190

(57) ABSTRACT

A heat sensitive recording material comprising a support and a heat sensitive recording layer containing a diazonium salt compound disposed on the support, wherein a compound represented by following formula (1) is contained in the heat sensitive recording material, as well as a microcapsule containing a diazonium salt compound and the compound represented by the following formula (1): 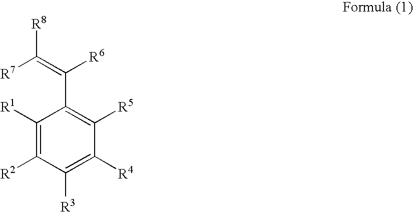
in which R¹ to R⁵ each independently represent a hydrogen atom, halogen atom or a substituted or non-substituted alkyl group, alkenyl group, aryl group, alkoxy group, or aryloxy group; R⁶ to R⁸ each independently represent a hydrogen atom or a substituted or non-substituted alkyl group or aryl group; and R¹ and R⁷, R¹ to R⁵, and R⁶ and R⁸ may join with each other to form a ring, providing that a ring formed by joining of R¹ and R⁷, or R⁶ and R⁸ does not form an aromatic ring.

### CROSS-REFERENCE TO RELATED APPLICATION

This application claims priority under 35 USC 119 from Japanese Patent Application Nos. 2004-149816 and 2004-149819, the disclosure of which are incorporated by reference herein.

### BACKGROUND OF THE INVENTION

1. Field of the Invention

The present invention relates to a heat sensitive recording material utilizing the reaction of a diazonium salt compound and a microcapsule that incorporates the diazonium salt compound and, more specifically, a heat sensitive recording material capable of effectively preventing photodecomposition stains from forming in a background portion after forming images and a microcapsule that can be used for the heat sensitive recording material.

2. Description of the Related Art

A diazonium salt compound is a compound of extremely high chemical activity and reacts with a compound referred to as a coupler having a phenol derivative or an active methylene group to easily form an azo dye, and it is also highly light sensitive and is decomposed under photoirradiation to lose the activity thereof. In view of the above, the diazonium salt compound has been conventionally utilized as a light recording material typically represented by diazo copy (refer, for example, to “Fundamentals of Photographic Engineering—Non-Silver Salt Photography Volume—” published by Corona Co. (1982) pp. 89 to 117.and pp. 182 to 201) (edited by the Society of Photographic Science and Technology of Japan).

Further, by utilizing the property of losing activity by photodecomposition, it has also been applied recently to a recording mnaterial in which fixation of images is required, and, as a typical example, a photofxing type heat sensitive recording material in which images are fixed by light irradiation after image formation is carried out by heating and reacting a recording material provided with a recording layer that contains a diazonium salt compound and a coupler in accordance with image signals has been proposed recently (refer, for example, to Hirotsugu Sato, et al., “Journal of the Institute of Image Electronics Engineers of Japan” vol. 11, No. 4 (1982) pp. 290 to 296).

However, in the recording materials using the diazonium salt compound as a color forming ingredient, since the chemical activity of the diazonium salt compound is extremely high, there is a problem in that colored decomposition products (stains) are formed by the decomposition of the diazonium compound during long-term storage to cause unnecessary coloration in nonimage areas. Further, in a case where the diazonium salt compound in the nonimage area is decomposed and fixed by irradiation of light, there is also a drawback in that the colored decomposition product of the diazonium salt compound is formed to color the nonimage area. Further, there is also a problem in that the light fastness of the non-image area is weak and the nonimage portion is colored strongly when completed images after fixing are exposed for a long time under sunlight or a fluorescent lamp.

As means for improving the instability of the diazonium salt compound, various methods have been proposed so far. One of the most effective means is a method of incorporating a diazonium salt compound in a microcapsule. By micro-encapsulating the diazonium salt compound, since the diazonium salt compound is isolated from a substance that promotes decomposition such as water or a base, the decomposition is suppressed remarkably (refer, for example, to Tomomasa Usami, et al., “Journal of the Institute of Electrophotography of Japan” vol. 26, No. 2 (1987), pp. 115 to 125).

That is, in a heat sensitive recording material having a heat sensitive recording layer containing a heat responsive-microcapsule containing a diazonium salt compound and containing a coupler outside of the capsule as the color forming main ingredient, the diazonium salt compound can be kept stably for a long time, and the same time, colored images can be formed easily by applying heating, and formed images can also be fixed by irradiation of light.

The stability of the recording material can be improved outstandingly by micro-encapsulation of the diazonium salt compound.

However, even when the diazonium salt compound is incorporated in the microcapsule, decomposition of the diazonium salt compound proceeds slightly. Accordingly, while an outstanding improvement is observed in the stability of the heat sensitive recording material, the instability due to the diazonium salt compound itself is not yet completely suppressed.

It has been known that the photodecomposing reaction of the diazonium salt compound is not a uniform reaction but that various decomposition products are formed depending on the surrounding environment, etc. The products include as many as several tens of kinds, and, among them, those referred to as photodecomposition stains having spectral absorption, particularly in the visible region, are formed. In a case where stains occur conspicuously, whiteness in the nonimage area (background portion) after photo-fixing is lowered and the contrast relative to the color forming area is also lowered to greatly deteriorate the commercial value of the recording material itself.

However, since the photodecomposing reaction of the diazonium salt compound is complicated and it is difficult to identify the products, suppression of the pohotodecomposition stains has been difficult.

Meanwhile, a heat sensitive recording material using a specified ester compound as a hydrophobic non-volatile ingredient of a microcapsule incorporating a diazo compound has been disclosed (refer, for example, to JP-A No. 8-324129). In addition, it has been also proposed to use a specified polymerizable oil as the hydrophobic non-volatile ingredient (refer, for example, to JP-A No. 2003-182222). However, even the means described above can not completely suppress the occurrence of photodecomposition stains, and further improvement has been demanded.

### SUMMARY OF THE INVENTION

A first aspect of the present invention is to provide a heat sensitive recording material comprising a support and a heat sensitive recording layer containing a diazonium salt compound disposed on the support, wherein a compound represented by following formula (1) is contained in the heat sensitive recording material: 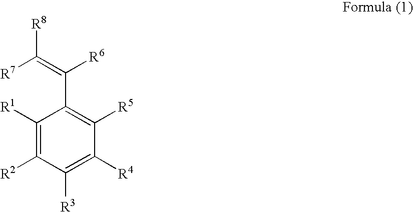
in which R¹ to R⁵ each independently represent a hydrogen atom, halogen atom or a substituted or non-substituted alkyl group, alkenyl group, aryl group, alkoxy group, or aryloxy group; R⁶ to R⁸ each independently represent a hydrogen atom, or a substituted or non-substituted alkyl group or aryl group; and R¹ and R⁷, R¹ to R⁵, and R⁶ and R⁸ may join with each other to form a ring, providing that a ring formed by joining of R¹ and R⁷, or R⁶ and R⁸ does not form an aromatic ring.

A second aspect of the invention is to provide a microcapsule containing a diazonium salt compound and a compound represented by following formula (1): 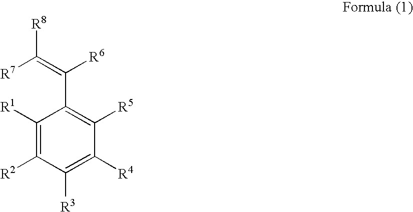
in which R¹ to R⁵ each independently represent a hydrogen atom, halogen atom or a substituted or non-substituted alkyl group, alkenyl group, aryl group, alkoxy group, or aryloxy group; R⁶ to R⁸ each independently represent a hydrogen atom or a substituted or non-substituted alkyl group or aryl group; and R¹ and R⁷, R¹ to R⁵, and R⁶ and R⁸ may join with each other to form a ring, providing that a ring formed by joining of R¹ and R⁷, or R⁶ and R⁸ does not form an aromatic ring.

### DETAILED DESCRIPTION OF THE INVENTION

The foregoing subject can be solved by the following invention. That is, the invention provides:
<1> a heat sensitive recording material provided with a heat sensitive recording layer containing a diazonium salt compound on a support, wherein a compound represented by the formula (1) is contained: 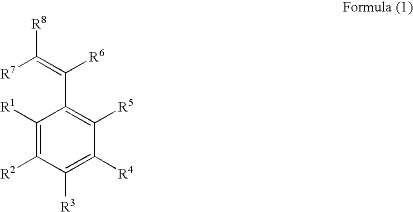
   in which R¹ to R⁵ each independently represent a hydrogen atom, halogen atom or a substituted or non-substituted alkyl group, alkenyl group, aryl group, alkoxy group, or aryloxy group; R⁶ to R⁸ each independently represent a hydrogen atom or a substituted or non-substituted alkyl group or aryl group; and R¹ and R⁷, R¹ to R⁵, and R⁶ and R⁸ may join with each other to form a ring, providing that a ring formed by joining of R¹ and R⁷, or R⁶ and R⁸ does not form an aromatic ring;
<2> the heat sensitive recording material according to <1> as described above, wherein the compound represented by formula (1) is contained in the heat sensitive recording layer;
<3> the heat sensitive recording material according to <1> described above, containing a coupler that reacts with the diazonium salt compound to form a color together with the diazonium salt compound, wherein the diazonium salt compound and the compound represented by formula (1) are incorporated in a microcapsule;
<4> the heat sensitive recording material according to <1> as described above, wherein each of R⁶ to R⁸ in the formula (1) is a hydrogen atom;
<5> the heat sensitive recording material according to <1> as described above, wherein at least one of R¹ to R⁵ in formula (1) is a vinyl group;
<6> the heat sensitive recording material according to <1> as described above, wherein at least one of R¹ to R⁵ is a vinyl group and each of R⁶ to R⁸ represents a hydrogen atom in formula (1);
<7> the heat sensitive recording material according to <1> as described above, wherein a compound selected from formulae (11) to (15) is contained as the diazonium compound; 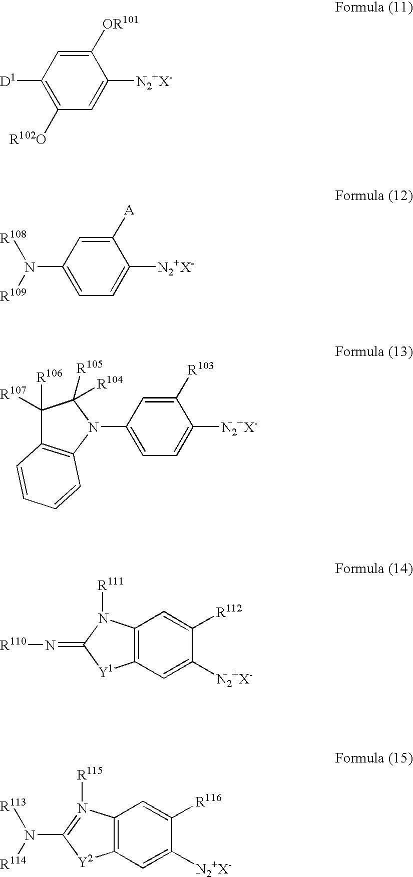
   wherein in formulae (11) to (15), R¹⁰¹ and R¹⁰², R¹⁰⁴ to R¹¹¹, and R¹¹³ to R¹¹⁵ may be identical to or different from each other and each represents a hydrogen atom, alkyl group, or aryl group; R¹⁰³, R¹¹², and R¹¹⁶ each represents a hydrogen atom, alkyl group, alkoxy group, halogen atom, sulfonyl group, acyl group, or alkoxycarbonyl group; D¹ represents an electron donating group with a Hammett's σp value of −0.05 or less, in which a substituted amino group, alkylthio group, arylthio group, alkoxy group, or aryloxy group is preferred; X⁻ represents a counter anion; A represents an electron attracting group with a Hammett's σp value of 0.3 or more; Y¹ and Y² each represents an oxygen atom or sulfur atom, and each of the benzene rings in formulae (11) to (15) may further have a substituent;
<8> the heat sensitive recording material according to <1> as described above, wherein a compound represented by following formula (16) is contained as the diazonium salt compound, 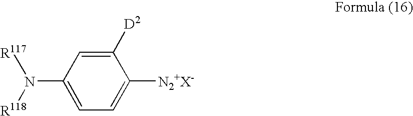
   wherein in formula (16), R¹¹⁷ and R¹¹⁸ each represents a hydrogen atom, alkyl group or aryl group; X⁻ represents a counter anion, and D² represents an alkoxy group or aryloxy group;
<9> the heat sensitive recording material according to <1> as described above, wherein a compound selected from following formulae (17) and (18) is contained as the diazonium salt compound, 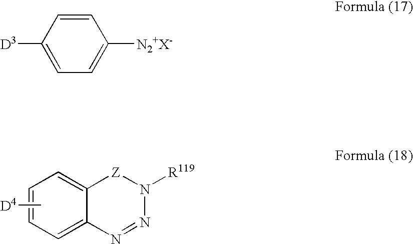
   wherein in formulae (17) and (18), D³ and D⁴ each represents a group with the Hammett's σp value of −0.45 or more; R¹¹⁹ represents a perfluoroalkyl group, acyl group, or sulfonyl group; X⁻ in formula (17) represents a counter anion; and Z in formula (18) represents —SO₂—,
<10> the heat sensitive recording material according to <1> as described above, wherein the material comprises a plurality of heat sensitive recording layers;
<11> the heat sensitive recording material according to <10> as described above, wherein the heat sensitive recording layer contains a diazonium salt compound with a maximum absorption wave length of 445±50 nm;
<12> the heat sensitive recording material according to <10> as described above, wherein the heat sensitive recording layer contains a diazonium salt compound with a maximum absorption wave length of 365±30 nm;
<13> the heat sensitive recording material according to <10> as described above, wherein the heat sensitive recording layer contains a diazonium salt compound with a maximum absorption wave length of 305±30 nm;
<14> a microcapsule containing a diazonium salt compound and a compound represented by following formula (1). 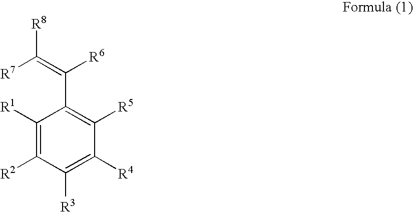
   wherein in formula (1), R¹ to R⁵ each independently represent a hydrogen atom, halogen atom or a substituted or non-substituted alkyl group, alkenyl group, aryl group, alkoxy group, or aryloxy group; R⁶ to R⁸ each independently represent a hydrogen atom or a substituted or non-substituted alkyl group or aryl group; and R¹ and R⁷, R¹ to R⁵, and R⁶ and R⁸ may join with each other to form a ring, providing that a ring formed by joining of R¹ and R⁷, or R⁶ and R¹ does not form an aromatic ring;
<15> the microcapsule according to <14> as described above, wherein a compound selected from following formulae (11) to (15) is contained as the diazonium salt compound, 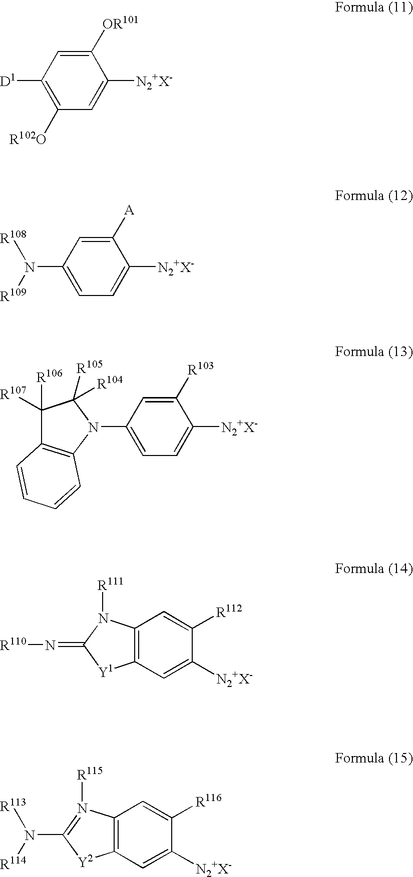
   wherein in formulae (11) to (15), R¹⁰¹, R¹⁰², and R¹⁰⁴ to R¹¹¹, R¹¹³ to R¹⁵ may be identical to or different from each other and each represents a hydrogen atom, an alkyl group or an aryl group; R¹⁰³, R¹¹², and R¹¹⁶ each represent a hydrogen atom, alkyl group, alkoxy group, halogen atom, sulfonyl group, acyl group or alkoxycarbonyl group; D¹ represents an electron donating group with a Hammett's σp value of −0.05 or less, in which a substituted amino group, alkylthio group, arylthio group, alkoxy group, or aryloxy group is preferred; X⁻ represents a counter anion; A represents an electron attracting group with a Hammett's σp value of 0.3 or more; and Y¹, Y² each represents an oxygen atom or sulfur atom, and each of the benzene rings in formulae (11) to (15) may further have a substituent;
<16> the microcapsule according to <14> as described above, wherein a compound represented by following formula (16) is contained as the diazonium salt compound, 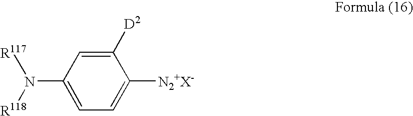
   wherein in formula (16), R¹¹⁷ and R¹¹⁸ each represents a hydrogen atom, alkyl group, or aryl group; X⁻ represents a counter anion; and D² represents an alkoxy group or aryloxy group;
X<17> the microcapsule according to <14> as described above, wherein a compound selected from following formulae (17) and (18) is contained as the diazonium salt compound, 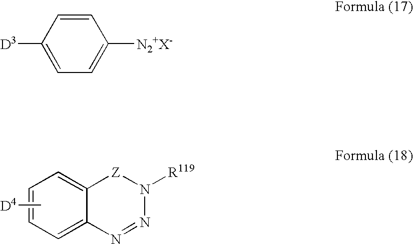
   wherein in formulae (17) and (18), D³ and D⁴ each represents a group with a Hammett's σp value of −0.45 or more; R¹¹⁹ represents a perfluoroalkyl group, acyl group or sulfonyl group; X⁻ in the general formula (17) represents a counter anion; and Z in formula (18) represents —SO₂—, —CO—.

The invention can provide a heat sensitive recording material effectively suppressing photodecomposed stains from forming in the background area after image formation by aging and exposure to light, as well as a microcapsule that can be used for the heat sensitive recording material.

The heat sensitive recording material according to the invention is a heat sensitive recording material provided with a heat recording layer containing a diazonium salt compound on a support, wherein a compound represented by following formula (1) is contained in the heat sensitive recording material; 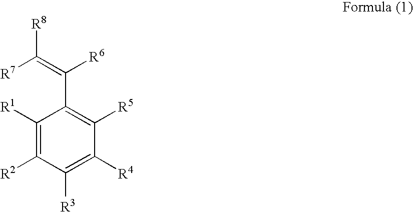
wherein in formula, which R¹ to R⁵ each independently represent a hydrogen atom, halogen atom or a substituted or non-substituted alkyl group, alkenyl group, aryl group, alkoxy group, or aryloxy group; R⁶ to R⁸ each independently represents a hydrogen atom or a substituted or non-substituted alkyl group or aryl group; R¹ and R⁷, R¹ to R⁵, and R⁶ and R⁸ may join with each other to form a ring, providing that a ring formed by joining of R¹ and R⁷, or R⁶ and R⁸ does not form an aromatic ring.

The heat sensitive recording material and the microcapsule according to the invention are to be described specifically. At first, description is to be made for a specific compounds as main constituent factors of the invention.

<Compound Represented by Formula (1)>

In formula (1), substituents represented by R¹ to R⁵ have no particular restriction and they can include, preferably, a halogen atom, alkyl group, alkenyl group, aryl group, alkoxy group, aryloxy group, etc.

The halogen atom represented by R¹ to R⁵ includes, for example, a fluorine atom, chlorine atom, bromine atom, iodine atom, etc.

The alkyl group represented by R¹ to R⁵ may be any of linear, branched linear, or cyclic form. Further, it may have a substituent and the substituent includes, for example, a halogen atom, aryl group, alkoxy group, aryloxy group, alkoxycarbonyl group, acyloxy group, acylamino group, carbamoyl group, cyano group, carboxylic acid group, sulfonic acid group, and heterocyclic group.

The alkyl group is preferably an alkyl group of 1 to 30 carbon atoms in total and includes, for example, methyl group, ethyl group, normal propyl group, isopropyl group, normal butyl group, isobutyl group, secondary butyl group, tertiary butyl group, normal hexyl group, cyclopentyl group, cyclohexyl group, heptyl group, octyl group, 2-ethylhexyl group, decyl group, dodecyl group, octadecyl group, 2-hydroxyethyl group, 2-benzoyloxyethyl group, 2-(4-butoxyphenoxy)ethyl group, benzyl group, monochloromethyl group, dichloromethyl group, trichloromethyl group, bromomethyl group, 2-chloroethyl group, 2-bromoethyl group, 2-methoxyethyl group, 2-ethoxyethyl group, phenylmethyl group, naphthylmethyl group, phenoxymethyl group, nonyl group, undecyl group, triphenylmethyl group, 4-methoxybenzyl group, ethoxycarbonyl methyl group, ethoxycarbonyl propyl group, and butoxycarbonyl methyl group.

The alkenyl group represented by R¹ to R⁵ may further have a substituent, and the substituent includes, for example, a halogen atom, aryl group, alkoxy group, aryloxyl group, alkoxycarbonyl group, acyloxy group, acylamino group, carbamoyl group, cyano group, carboxylic group, sulfonic group, and heterocyclic group.

As the alkenyl group, an alkenyl group of 2 to 20 carbon atoms in total is preferred and vinyl group is particularly preferred. Specifically, it includes, for example, 1-methylvinyl group, 2-methylvinyl group, 1,2-dimethylvinyl group, 2-phenylvinyl group, 2-(p-methylphenyl)vinyl group, 2-p-methoxyphenyl)vinyl group, 2-(p-chlorophenyl)vinyl group, and 2-(o-chlorophenyl)vinyl group. The aryl group represented by R¹ to R⁵ may further have a substituent and the substituent includes, for example, a halogen atom, alkyl group, aryl group, alkoxy group, aryloxy group, alkokycarbonyl group, acyloxy group, acylamino group, carbamoyl group, cyano group, carboxylic group, sulfonic group, and heterocyclic group.

As the aryl group, an aryl group of 6 to 30 carbon atoms in total is preferred, and it includes, for example, a phenyl group, 4-nethylphenyl group, 3-methylphenyl group, 2-methylphenyl group, 4-chlorophenyl group, 2-chlorophenyl group, 4-nitrophenyl group, 4-acetoamidephenyl group, 4-octanoylaminophenyl group, 44-methylphenylsulfonylamino) phenyl group, 2,4,6-trimethylphenyl group, 4-benzylphenyl group, 2-methoxyphenyl group, 3-methoxyphenyl group, 4-methoxyphenyl group, 3,4-dimethoxyphenyl group, 2-ethoxyphenyl group, 3-ethoxyphenyl group, 4-ethoxyphenyl group, 2-propoxyphenyl group, 4-butoxyphenyl group, 2-oxtyloxyphenyl group, and 4-ethoxycarbonylphenyl group.

The alkoxy group represented by R¹ to R⁵ may further have a substituent and the substituent includes, for example, an aryl group, halogen atom, alkoxy group, aryloxy group, alkoxycarbonyl group, acyloxy group, acylamino group, carbamoyl group, cyano group, carboxylic group, sulfonic group, and heterocyclic group.

As the alkoxy group, an alkoxy group of 1 to 20 carbon atoms in total is preferred and it includes, for example, a methoxy group, ethoxy group, normal propyloxy group, isopropyloxy group, normal butyloxy group, tertiary butyloxy group, normal pentyloxy group, 3-pentyloxy group, normal hexyloxy group, normal octyloxy group, 2-ethylhexyloxy group, 3,5,5-trimethylhexyloxy group, normal decyloxy group, normal dodecyloxy group, cyclohexyloxy group, benyzloxy group, allyloxy group, methallyloxy group, prenyloxy group, 2-methoxyethoxy group, 2-ethoxyethoxy group, 2-phenoxyethoxy group, 2-(2,5-di-tertiary amylphenoxy)ethoxy group, 2-benzoyloxyethoxy group, methoxycarbonylmethyloxy group, methoxycarbonylethyloxy group, butoxycarbonylethyloxy group, and 2-isopropyloxyethyloxy group.

The aryloxy group represented by R¹ to R⁵ may further have a substituent and the substituent includes, for example, a halogen atom, alkyl group, aryl group, alkoxy group, aryloxy group, alkoxycarbonyl group, acyloxy group, acylamino group, carbamoyl group, cyano group, carboxylic group, sulfonic group, and heterocyclic group.

The aryloxy group is preferably an aryloxy group of 6 to 10 carbon atoms in total and includes, for example, a phenoxy group, 4-methylphenoxy group, 2-methylphenoxy group, 2-chlorophenoxy group, 4-methoxyphenoxy group, 4-carboxyphenoxy group, and 3-ethoxycarboxyphenoxy group.

In formula (1), the ring formed by joining of R¹ and R⁷ includes cyclopentene, cyclohexene, furan, pyran, and pyrone. However, R¹ and R⁷ do not form an aromatic ring.

In formula (1), the ring formed by joining each of R¹ to R⁵ includes cyclopentene, cyclopentadiene, cyclohexene, cyclohexadiene, furan, pyran, and pyrone.

Further, the alkyl group and the aryl group represented by R⁶ to R⁸ include those set forth for R¹ to R⁵.

Further, the ring formed by joining of R⁶ and R⁸ includes those set forth for the ring formed by joining of R¹ and R⁷. However, R⁶ and R⁸ do not form an aromatic ring.

In the compound represented by formula (1), at least one group represented by R¹ to R⁵ is preferably a vinyl group, and the group represented by R⁶ to R⁸ is preferably a hydrogen atom. Further, it is particularly preferred that at least one of the groups represented by R¹ to R⁵ is a vinyl group and the group represented by R⁶ to R¹ is a hydrogen atom.

Specific examples of the compounds represented by formula (1) (compounds (1) to (21)) are shown below, but the invention is not restricted to them.

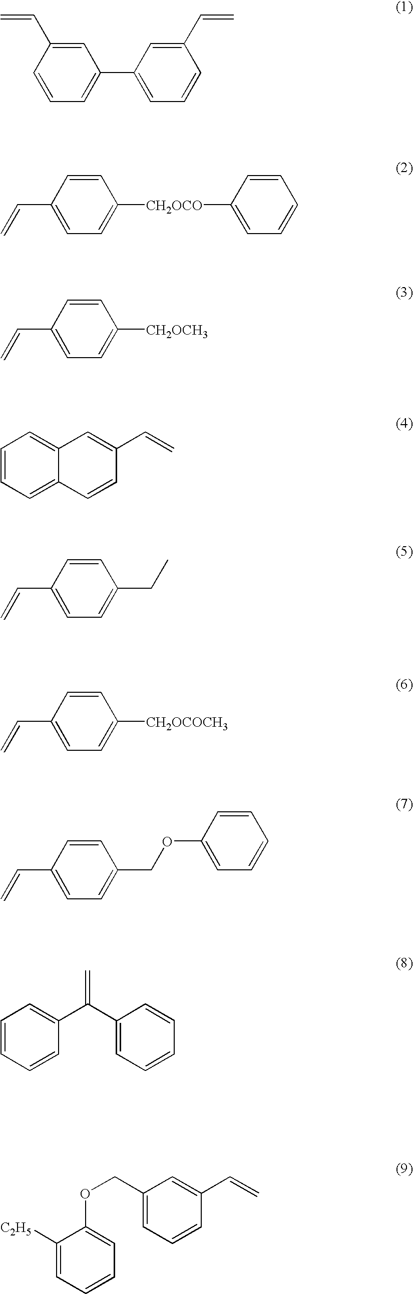

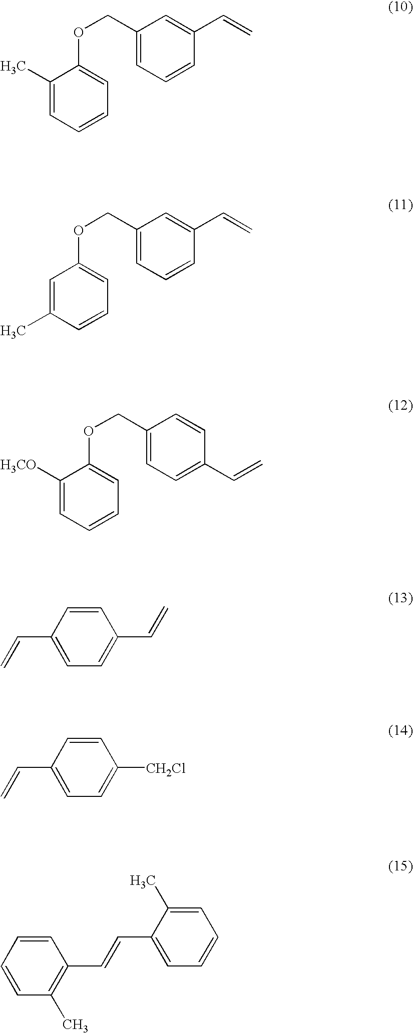

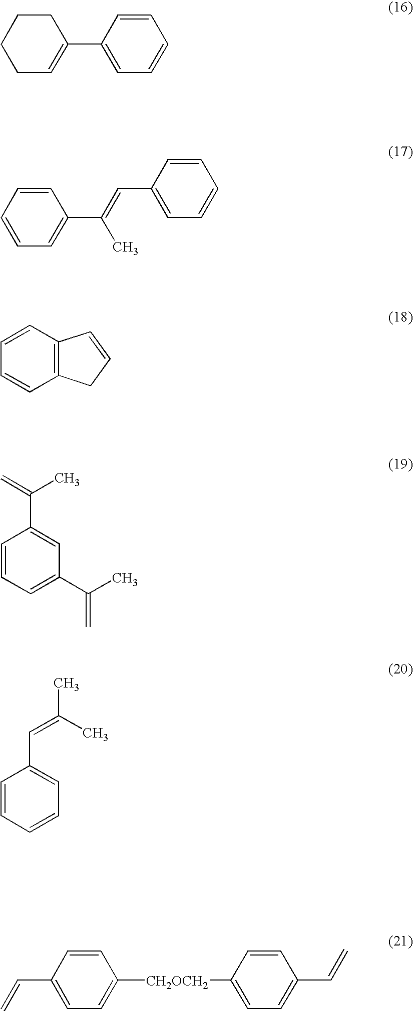

In addition to the above specific examples of the compounds, 4-vinylbenzyl 2(4-vinylbenzyloxy)benzoate is preferrable.

In the invention, the compound represented by formula (1) may be contained in any of the layers in the heat sensitive recording material, such as in a heat sensitive recording layer, light transmittance control layer, protective layer, intermediate layer, etc. and a form where it is contained in the heat sensitive recording layer is preferred with a view point of effectively preventing photodecomposed stains, and a form where it is incorporated together with a diazonium salt compound to be described later in a microcapsule to be described later is particularly preferred. Further, the compound may be used singly, or two or more of compounds may be used in combination.

The content of the compound represented by formula (1) based on 100 mass parts of the diazonium salt compound to be described later is, preferably, from 25 to 500 mass pasts and, more preferably, from 50 to 250 mass parts. When the content is within the range described above, photodecomposed stains can be prevented effectively.

The layer constitution of the heat sensitive recording material according to the invention is to be described.

<Heat Sensitive Recording Layer>

In the heat sensitive recording material of the invention, known diazonium salt compounds and couplers can be used as the color forming ingredient.

(Diazonium Salt Compound)

The known diazonium salt compound includes, for example, a diazonium salt compound represented by following formula (A):
Ar—N₂⁺X₁⁻ formula (A)
wherein Ar represents a substituted or non-substituted aryl group, and X₁⁻ represents an acid anion).

The diazonium salt compound represented by formula (A) is a compound that takes place coupling reaction with the coupler to be described later by heating and is decomposed by light. The maximum absorption wavelength can be controlled depending on the position and the kind of the substituent at the Ar portion.

In formula (A), Ar represents a substituted or non-substituted aryl group.

The aryl group represented by Ar is preferably an aryl group of 6 to 30 carbon atoms, and includes, for example, a phenyl group, 2-methylphenyl group, 2-chlorophenyl group, 2-methoxyphenyl group, 2-butoxyphenyl group, 2-(2-ethylhexyloxy)phenyl group, 2-octyloxyphenyl group, 3-(2,4-di-t-pentylphenoxyethoxy)phenyl group, 4-chlorophenyl group, 2,5-dichlorophenyl group, 2,4,6-trimethylphenyl group, 3-chlorophenyl group, 3-methylphenyl group, 3-methoxyphenyl group, 3-butoxyphenyl group, 3-cyanophenyl group, 3(2-ethylhexyloxy)phenyl group, 3,4-dichlorophenyl group, 3,5-dichlorophenyl group, 3,4-dimethoxyphenyl group, 3-dibutylaminocarbonylmethoxy) phenyl group, 4-cyanophenyl group, 4-methylphenyl group, 4-methoxyphehyl group, 4-butoxyphenyl group, 42-ethylhexyloxy)phenyl group, 4-benzylphenyl group, 4-aminosulfonylphenyl group, 4N,N-dibutylaminosulfonylphenyl group, 4-ethoxycarbonylphenyl group, 42-ethylhexylcarbonyl)phenyl group, 4-(4-fluorophenyl group, 3-acetylphenyl group, 2-acetylaminophenyl group, 4-(4-chlorophenylthio)phenyl group, 4-(4-methylphenyl)thio-2,5-butoxyphenyl group, and 4N-benzyl-N-nethylamino)-2-dodecyloxycarbonylphenyl group. Further, the groups described above may be substituted with an alkyl group, alkoxy group, alkylthio group, aryl group, aryloxy group, arylthio group, acyl group, alkoxycarbonyl group, carbamoyl group, carboamide group, sulfonyl group, sulfamoyl group, alkyloxy group, cyano group, amino group, substituted amino group, halogen atom, heterocyclic group, sulfoneamide group, ureido group, heterocyclic group, etc., and such group may further be substituted.

In the invention, a preferable diazonium salt compound is the compound substituted with an electron-donating group in an aromatic ring (Ar) portion. When the diazonium salt compound substituted with an electron-donating group in an aromatic ring portion is used in a recording material of the invention, the effect of preventing photodocomposition stains is remarkable. The electron-donating group represents a substituent group with a Hammette's σp of negative value. (Chem. Rev., 1991, pp. 91 and pp. 165-195) Among electron-donation groups, an alkoxy group, an arylocy group, a substituted amino group, an alkylthio group or an arylthio group is preferrable, and particularly preferable is an alkoxy group or a dialkylamino group. Substitution of an electron-donating group at the ortho (o-position) and/or the para (p-position) of the diazonium group on the benzene ring is preferred. Preferred specific structure of a diazonium salt compound is formula (11) or formula (12), and more preferred is formula (12).

Specific examples of diazonium forming the diazonium salt compound represented by the general formula (A) includes, for example, 4-(p-tolylthio)-2,5-dibutoxybenzene diazonium, 4-(4-chlorophenylthio)-2,5-dibutoxybenzene diazonium, 4-(N,N-dimethylamino)benzene diazonium, 4-(N,N-diethylamino)benzene diazonium, 4-(N,N-dipropylamino) benzene diazonium, 4-(N-methyl-N-benzylamino)benzene diazonium, 4-(N,N-dibenzylamino)benzene diazonium, 4-(N-ethyl-N,N-hydroxyethylamino)benzene diazonium, 4-(N,N-diethylamino)-3-methoxybenzenze diazonium, 4-(N,N-dimethylamino-2-methoxybenzenze diazonium, 4-(N-benzoylamino)-2,5-diethoxybenzene diazonium, 4-morpholino-2,5-dibutoxybenzenze diazonium, 4-anilinobenezene diazonium, 4-[N-(4-methoxybenzoyl)amino]-2,5-diethoxybenzene diazonium, 4-pyrolidino-3-ethylbenzene diazonium, 4-[N-(1-methyl-2-(4-methoxyphenoxy)ethyl)-N-hexylamino]-2-hexyloxybenzene diazonium, 4-[N-(2-(4-methoxyphenoxy)ethyl)-N-hexylamino]-2-hexyloxybenzene diazonium, 2-(1-ethylpropyloxy)-4-[di(di-n-butylaminocarbonylmethyl)amino]benzene diazonium, and 2-benzylsulfonyl-4-[N-methyl N-(2-octanoyloxyethyl)]aminobezene diazonium.

X₁⁻ represents an acid anion and the acid anion includes a polyfluoroalkyl carboxylic acid of 1 to 9 carbon atoms, a polyfluoroalkyl sulfonic acid of 1 to 9 carbon atoms, boron tetrafluoride, tetraphenyl boron, hexafluorophosphoric acid, aromatic carboxylic acid, aromatic sulfonic acid and the like. Among them, hexafluorophosphoric acid is preferred in view of the crystallinity.

The maximum absorption wavelength: λmax of the known diazonium salt compound may be properly selected depending on the layer in which the compound is used, etc. and it is, preferably, 495 nm or less and, more preferably, 290 to 440 nm. In a case where λmax is in a longer wavelength region exceeding 495 nm, unprocessed stock storability may be sometimes lowered. On the other hand, in a case where it is in a shorter wavelength region than the wavelength range described above, the image fixing property or image storability is sometimes lowered or the hue may sometimes be degraded in the combination with the coupler to be described later.

Further, it is preferred that the diazonium salt compound has the number of carbon atoms of 12 or more, the solubility to water of 1 mass % or less, and the solubility to ethyl acetate of 5 mass % or more.

The diazonium salt compound may be used singly or two or more of the compounds may be used in combination in accordance with the purpose such as control for the hue.

The diazonium salt compound used in the invention is, preferably, used in a range from 0.02 to 3 g/m² in the heat sensitive recording layer and it is, preferably, used within a range of 0.1 to 2 g/m² with a view point of color forming density.

The heat sensitive recording material of the invention may be either a mono-color heat sensitive recording material having one heat sensitive recording layer on a support, or a multi-color heat sensitive recording material having a heat sensitive recording layer of a layered structure where plural mono-color recording layers are stacked. While the details for the multi-color heat sensitive recording material are to be described later, description is to be made herein for the diazonium salt compound that can be used suitably in a case of a full color heat sensitive recording layers containing cyan, yellow and magenta.

As will be described later, preferred heat sensitive recording materials include a form in which all of three layers on a support are constituted with diazo color forming agents, or a form where the heat sensitive recording layer at the first layer near the support is constituted with an electron donating dye and leuco color forming agent containing an electron accepting compound and the heat sensitive recording layers for the second and the third layers are constituted each with a diazo color forming agent but description is to be made to the example where all of the three layers are constituted with the diazo color forming agents.

It is preferred to incorporate a diazonium salt compound having a maximum absorption wavelength of 445±50 nm to the layer most remote from the support (layer C), a diazonium salt compound having a maximum absorption wavelength of 365±30 nm to the layer therebelow (layer B), and a diazonium salt compound having a maximum absorption wavelength of 305±30 nm to the layer nearest to the support (layer A).

Details for the diazonium salt compounds are described in JP-A Nos. 4-59287, 4-59288, 10-337961, 11-78233, 11-116553, 7-223368, 7-323660, 7-125446, 746671, 2001-162946, and 2002-326981, JP-B Nos. 3-213120, 3-394613, and 8-310133, and Japanese Patent Application Nos. 2002-241646, and 2002-261318.

Diazonium Salt Compound Having Maximum Absorption Wavelength of 445±50 nm (DA Compound)

In a case where the maximum absorption wavelength exceeds the upper limit, the stability of the diazonium salt compound is deteriorated to lack in practicality. On the other hand, if it goes below the lower limit, this is within the range of the maximum absorption wavelength region of the diazonium salt compound having the maximum absorption wavelength of 365±30 nm, which is not preferred. The range of the maximum absorption wavelength of the diazonium salt compound (DA compound) is, more preferably, 395 to 475 nm.

The diazonium salt compound having the maximum absorption wavelength of 445±50 nm is, preferably, a diazonium salt compound represented by formulae (11) to (15).

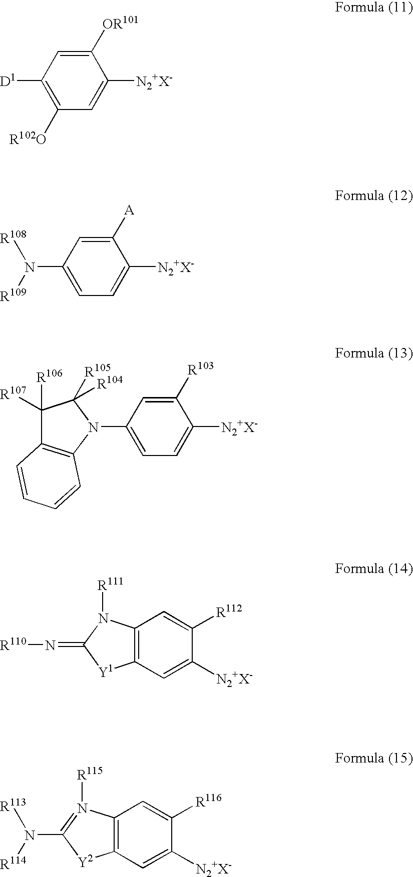

In formulae (11) to (15), R¹⁰¹ and R¹⁰², R¹⁰⁴ to R¹¹¹ and R¹¹³ to R¹¹⁵ may be identical to or different from each other and each represents a hydrogen atom, alkyl group, or aryl group; R¹⁰³, R¹¹², and R¹¹⁶ each represents a hydrogen atom, alkyl group, alkoxy group, halogen atom, sulfonyl group, acyl group, or alkoxycarbonyl group; D¹ represents an electron donating group with a Hammett's σp value of −0.05 or less, in which a substituted amino group, alkylthio group, arylthio group, alkoxy group, or aryloxy group is preferred. X⁻ represents a counter anion. A represents an electron attracting group with a Hammett's σp value of 0.3 or more. Y¹ and Y² each represents an oxygen atom or sulfur atom. Each of the benzene rings in formulae (11) to (15) may further have a substituent.

R¹⁰¹ and R¹⁰², R¹⁰⁴ to R¹¹¹, and R¹¹³ to R¹¹⁵ each preferably represents a hydrogen atom, alkyl group of 1 to 15 carbon atoms, or aryl group of 6 to 10 carbon atoms. Particularly, the hydrogen atom, alkyl group of 1 to 10 carbon atoms, and the phenyl group are preferred. The alkyl group may be branched and may be substituted with a halogen atom, alkoxy group, aryloxy group, phenyl group, alkoxycarbonyl group, acyloxy group, or carbamoyl group. Further, the phenyl group may be substituted with a halogen atom, alkyl group, aryl group, acyloxy group, alkoxy group, aryloxy group, alkoxycarbonyl group, or acyl group.

R¹⁰¹ and R¹⁰², R¹⁰⁴ to R¹¹¹ and R¹¹³ to R¹¹⁵ include specifically, for example, those shown below.

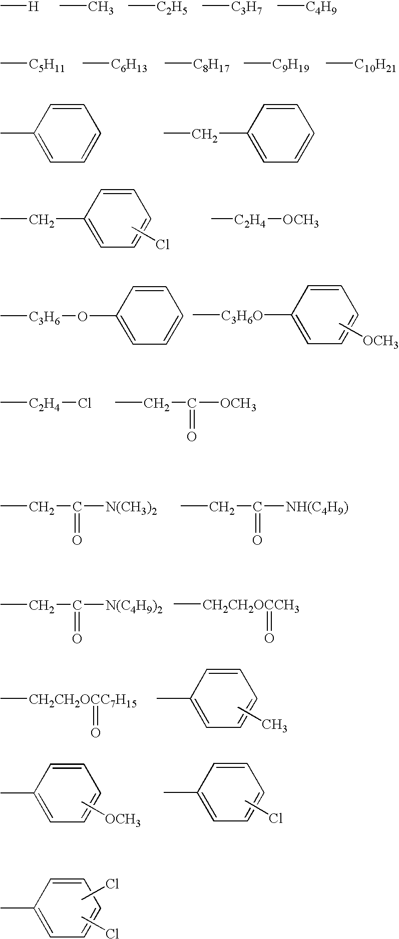

R¹⁰³ R¹¹², and R¹¹⁶ each preferably represents a hydrogen atom, alkyl group of 1 to 8 carbon atoms, chlorine atom, fluorine atom, alkoxy group of 1 to 15 carbon atoms, alkylsulfonyl group of 1 to 12 carbon atoms, arylsulfonyl group of 6 to 18 carbon atoms, acyl group of 1 to 18 carbon atoms, or alkoxycarbonyhl group of 1 to 18 carbon atoms. The alkyl group or alkylsulfonyl group may be branched, and may be substituted with a halogen atom, alkoxy group, aryloxy group, phenyl group, alkoxycarbonyl group, acyloxy group, or carbamoyl group.

The arylsulfonyl group may be substituted with a halogen atom, alkyl group, or alkoxy group.

R¹⁰³, R¹¹², and R¹¹⁶ include specifically, for example, those show below.

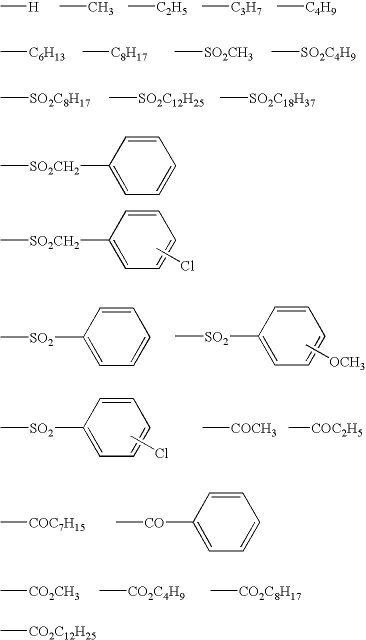

A is preferably a sulfonyl group, acyl group, alkoxy carbonyl group, or cyano group. The sulfonyl group, acyl group, or alkoxycarbonyl group have the same meaning as the sulfonyl group, acyl group or alkoxy carbonyl group represented by R¹⁰³.

R¹⁰⁸ and R¹⁰⁹, and R¹¹³ and R¹¹⁴ may join with each other to form a ring.

Examples of the counter anion X⁻ are preferably a perfluoroalkylcarboxylic acid of 1 to 20 carbon atoms (for example, perfluorooctanoic acid, perfluorodecanoic acid and perfluorododecanoic acid), perfulroalkyl sulfonic acid of 1 to 20 carbon atoms (for example, perfluorooctane sulfonic acid, perfluorodecane sulfonic acid, and perfluorohexadecane sulfonic acid), aromatic carboxylic acid of 7 to 50 carbon atoms (for example, 4,4-di-t-butylsalicylic acid, 4-t-octyloxy benzoic acid, 2-n-octyloxy benzoic acid, 4-t-hexadecyl benzoic acid, 2,4-bis-n-octadecyloxy benzoic acid, and 4-n-decyl naphthoic acid).

With a view point of the stability of the diazonium salt compound, D¹ is preferably a dialkylamino group, N-alkyl-N-arylamino group, acylamino group, alkylthio group, arylthio group, alkoxy group and aryloxy group.

The alkyl group or the aryl group in the substituted amino group, alkylthio group, arylthio group, alkoxy group, or aryloxy group which is an electron donating group represented by D¹ with the Hammett's σp value of −0.05 or less includes the followings.

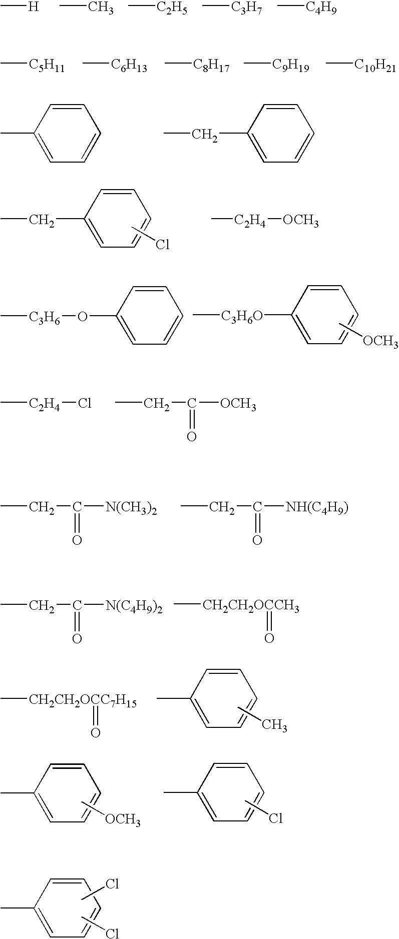

The cyclic amino group formed by bonding of substituents to each other in a case where D¹ in the formula (11) shows a substituted amino group, —N(R¹⁰⁸)(R¹⁰⁹) in the formula (12) and N(R¹¹³)(R¹¹⁴) of cyclic form in the formula (15) include, for example, the followings.

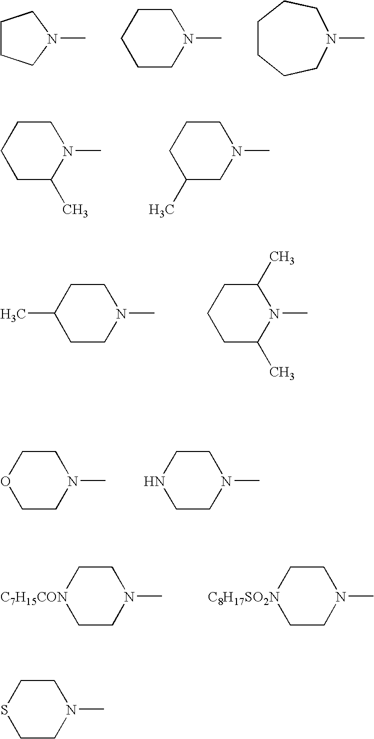

The benzene ring on the indolyl group of formula (13) may also have a ring-substituent, and, particularly, an electron attracting group is preferred with a view point of the ring stability. The Hammett's σp value of the electron attracting group is, preferably, 0.1 or more. Among all, an acyl group, sulfonyl group, alkoxycarbonyl group, sulfoneamide group, or carbonamide group is preferred. The acyl group, sulfonyl group, and alkoxycarbonyl group are identical with those for R¹⁰³ and preferred forms are also identical. The sulfoneamide group is, preferably, those of 1 to 12 carbon atoms and, specifically, includes the followings.

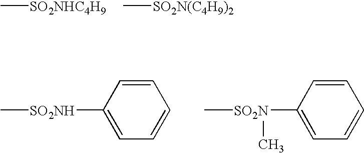

The carbonamide group is, preferably, those of 2 to 13 carbon atoms and, specifically, includes the followings.

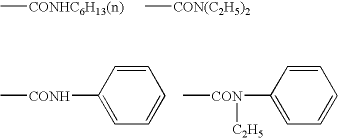

Specific examples of the diazonium salt compound (DA compound) represented by formulae (11) to (15) (exemplified compounds (DA1) to (DA16)) are shown below but the invention is not restricted thereto.

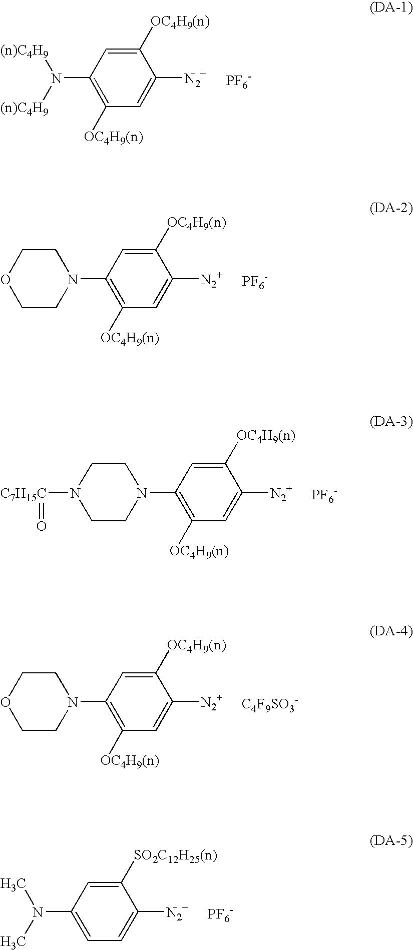

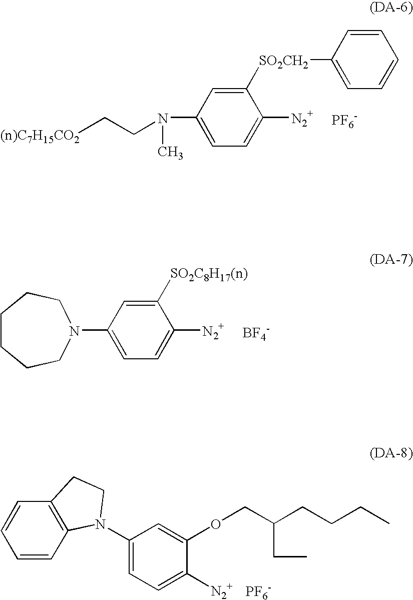

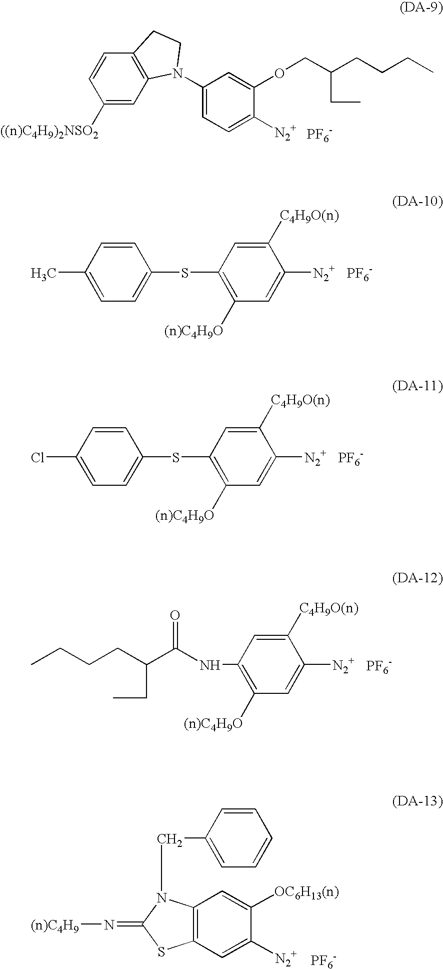

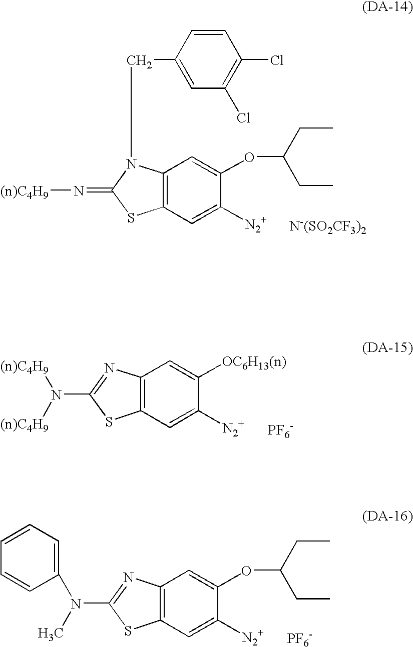

Diazonium Salt Compound of Maximum Absorption Wavelength of 365±30 nm (DB Compound)

In a case where the maximum absorption wavelength exceeds the upper limit, this is within the maximum absorption wavelength range of diazonium salt compound within the maximum absorption wavelength of 445±50 nm, which is not preferred. On the other hand, if it goes below the lower limit, this results in degradation of the stability and photodecomposing of the diazonium salt compound. The range for the maximum absorption wavelength of the diazonium salt compound (DB compound) is, more preferably, 350 to 375 nm.

As the diazonium salt compound with the maximum absorption wavelength of 365±30 nm, the diazonium salt compound represented by following formula (16) is preferred.

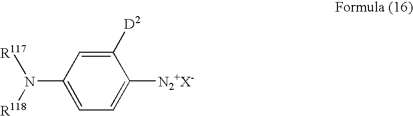

In formula (16), R¹¹⁷ and R¹⁸ are identical with R¹⁰¹ and preferred examples are also identical. X⁻ represents a counter anion and specific examples and preferred examples are what has been described above.

D² represents an alkoxy group or aryloxy group. The alkyl moiety in the alkoxy group and the aryl moiety in the aryloxy group are identical with that in the alkyl group and the aryl group represented by R¹⁰¹ and preferred examples are also identical.

Specific examples of the diazonium salt compound represented by the formula (16) (exemplified compounds (DB-1) to (DB-8) are shown below, but the invention is not restricted to them.

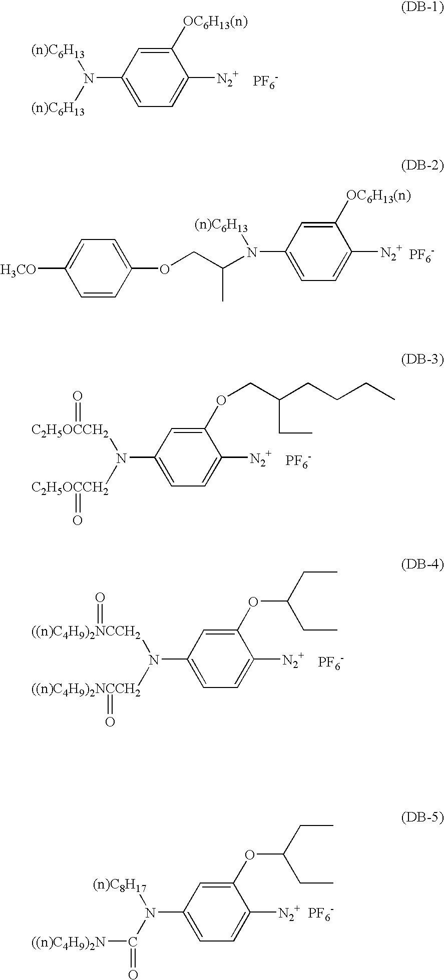

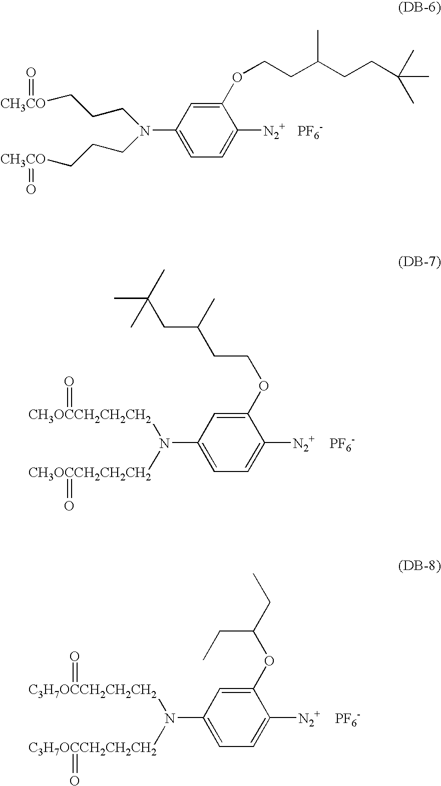

Diazonium Salt Compound of Maximum Absorption Wavelength of 305±30 nm (DC compound)

In a case where the maximum absorption wavelength exceeds the upper limit, this is within the range of the maximum absorption wavelength of the diazonium salt compound with the maximum absorption wavelength of 365±30 nm, which is not preferred. On the other hand, when it goes below the lower limit, this results in degradation of the stability of the diazonium salt compound. The range for the maximum absorption wavelength of the diazonium salt compound (DC compound) is, more preferably, 280 to 325 nm.

As the diazonium salt compound with the maximum absorption wavelength of 305±30 nm, the diazonium salt compound represented by following formulae (17) and (18) is preferred.

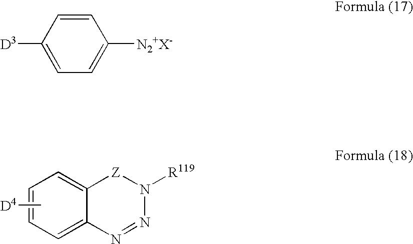

In formulae (17) and (18), D³ and D⁴ each represents a group with the Hammett's σp value of −0.45 or more. R¹¹⁹ represents a perfluoroalkyl group, acyl group or sulfonyl group, and the acyl group and sulfonyl group are identical with R¹⁰³.

The perfluoroalkyl group is, preferably, those of 1 to 8 carbon atoms and, particularly preferably, —CF₃, —C₃F₇ or —C₈F₁₇.

X⁻ in formula (17) represents a counter anion. Z in formula (18) represents —SO₂— or —CO—.

D³ and D⁴ represents the group with a Hammett's σp value of −0.45 or more are, preferably, an alkoxy group, aryloxy group, alkyl group, alkylthio group, arylthio group, halogen atom, hydrogen atom, nitro group, cyano group, alkylsulfonyl group, and alkoxycarbonyl group. A group with the Hammett's σp value of −0.30 or more is further preferred.

The alkoxy group is preferably an alkoxy group of 1 to 20 carbon atoms that can be substituted and includes, for example, methoxy (σp=−0.27), ethoxy, butyloxy (σp=−0.32), hexyloxy, octyloxy, 2-ethylhexyloxy, 3-methyl-5,5-dimethylhexyloxy, decyloxy, phenoxyethoxy, and 2-(2,4-di-t-pentylphenyl)oxyethyloxy.

The aryloxy group is preferably an aryloxy group of 6 to 20 carbon atoms that can be substituted and includes, for example, phenoxy (σp=−0.03), methylphenoxy, isopropylphenoxy, 2,4-di-t-pentylphenoxy, chlorophenoxy, and methoxyphenoxy.

The alkyl group is preferably an alkyl group of 1 to 8 carbon atoms and includes, for example, methyl (σp=−0.17), ethyl, isopropyl, t-butyl, hexyl, and octyl.

The alkylthio group is preferably an alkylthio group of 1 to 8 carbon atoms that can be substituted and includes, for example, methylthio, ethylthio (σp=0.03), butylthio, octylthio, and benzylthio.

The arylthio group is preferably an arylthio group of 6 to 10 carbon atoms that can be substituted and includes, for example, phenylthio (σp=0.18), methylphenylthio, chlorophenylthio, and methoxyphenylthio.

The halogen atom is preferably a chlorine atom (σp=0.23) and fluorine atom (σp=0.06).

The alkylsulfonyl group is preferably an alkylsulfonyl group of 1 to 8 carbon atoms and includes, for example, methyl sulfonyl (σp=0.72), ethylsulfonyl, butyl sulfonyl, octyl sulfonyl, and benzyl sulfonyl.

The alkoxycarbonyl group is preferably an alkoxycarbonyl group of 2 to 10 carbon atoms and includes, for example, methoxycarbonyl, ethoxycarbonyl (σp=0.45), butyloxycarbonyl, and octyloxycarbonyl.

X⁻ in formula (17) is identical to that in formula (11).

The benzene ring in the formulae (17) and (18) may further have a substituent.

The substituent may be any substituent and an alkyl group, alkoxy group, aryloxy group, alkylthio group, arylthio group, halogen atom, nitro group, cyano group, alkylsulfonyl group, and alkoxycarbonyl group are preferred. The alkyl group, alkoxy group, alkylthio group, arylthio group, halogen atom, alkylsulfonyl group, and alkoxycarbonyl group are identical with substituents corresponding respectively to those in D³.

In formula (17), substitution at the ortho (o-position) of the diazonium group on the benzene ring is preferred.

Specific examples of the diazonium salt compound represented by formulae (17) and (18) (exemplified compounds (DC-1) to (DC-6)) are to be described below, however, the invention is not restricted to the followings. 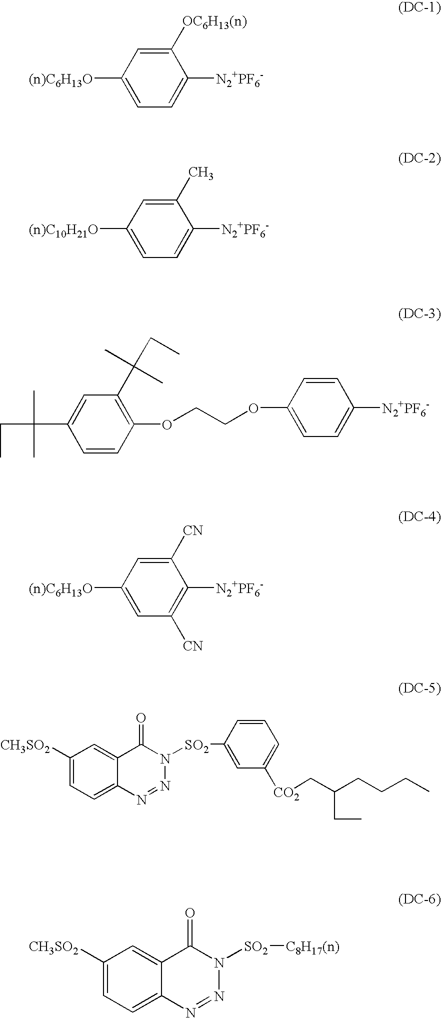
(Coupler)

For the coupler that takes place coupling reaction with the diazonium salt compound described above to form a dye and develop a color, any compound can be used so long as it can couple with the diazonium salt compound to form a dye in a basic atmosphere and/or neutral atmosphere and can be selected properly within a range conforming the purpose such as hue.

The coupler can include, for example, resorcin, fluoroglucin, sodium 2,3-dihydroxynaphthalene-6-sulfonate, sodium 2-hydroxy-3-naphthalene sulfonate, 2-hydroxy-3-naphthalene sulfonic acid anilide, 2-hydroxy-3-naphthalene sulfonic acid morpholinoamide, 2-hydroxy-3-naphthalene sulfonic acid morpholino propylamide, 2-hydroxy-3-naphthalene sulfonic acid-2-ethylhexyloxy propylamide, 2-hydroxy-3-naphthalene sulfonic acid-2-ethylhexylamide, sodium 1-hydroxy-8-acetylamino naphthalene-1,6-disulfonate, 1-hydroxy-8-acetylamino naphthalene-3,6-disulfonic acid dianilide, 1-hydroxy-2-naphthoic acid morpholino propylamide, 1,3-dihydroxynaphthalene, 2,2-dihydroxynaphthalene, 2,3-dihydroxyaphthalene sulfonic acid anilide, 2-hydroxy-3-naphthoic acid morpholinopropyl amide, 2-hydroxy-3-naphthoic acid anilide, 2-hydroxy-3-naphthoic acid-2′-methyl anilide, 2-hydroxy-3-naphthoic acid ethanolamide, 2-hydroxy-3-naphthoic acid octylamide, 2-hydroxynaphthoic acid morpholinoethylamide, 2-hydroxynaphthoic acid pyperidino propylamide, 2-hydroxynaphthoic acid pyperidinoethylamide, 2-hydroxy-3-naphthoic acid-N-dodecyl-oxy-propylamide, 2-hydroxy-3-naphthoic acid tetradecylamide, 6-methoxy-2-hydroxy-3-naphthoic acid anilide, 6-ethoxy-2-hydroxy-3-naphthoic acid anilide, 6-methoxy-2-hydroxy-3-naphthoic acid morpholino propylamide, 6-methoxy-2-hydroxy-3-naphthoic acid-2-hydroxyethylamide, acetoanilide, acetoacetoanilide, 2-chloro-3(2,4-di-1-amylphenoxy propylaminocarbonyl)-pivaloyl acetoanilide, benzoyl acetoanilide, 1-phenyl-3-methyl-5-pyrazolone, 1(2′,4′,6′-trichlorophenyl)-3-benzamide-5-pyrazolone, 1-(2′,4′,6′-trichlorophenyl)-3-anilino-3-pyrazolone, and 1-phenyl-3-phenylacetoamide-5-pyrazolone.

Details for the coupler are described, for example, in JP-A Nos. 4-201483, 7-223367, 7-223368, 7-323660, 7-125446, 7-96671, 7-223367, 7-223368, 9-156229, 9-216468, 9-216469, 9-203472, 9-319025, 10-35113, 10-193801, and 10-264532.

Further, among them, a compound represented by the following formula (19) or a tautomer thereof is particularly preferred.

The coupler represented by following formula (19) is to be described specifically

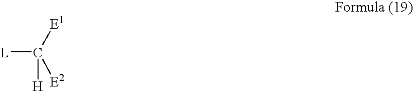

In formula (19), E¹ and E² each represents independently an electron attracting group, L represents a group that can split upon azo-coupling to form an azo dye. E¹ and E² may join to each other to form a ring.

The electron attracting groups represented by E¹ and E² described above means a substituent having a positive Hammett's σp value which may be identical or different with each other and, preferably, include, for example, acyl groups such as acetyl group, propionyl group, pivaloyl group, chloroacetyl group, trichloroacetyl group, trifluoroacetyl group, 1-methylcyclopropylcarbonyl group, 1-ethylcyclopropylcarbonyl group, 1-benzylcyclopropylcarbonyl group, benzoyl group, 4-methoxybenzoyl group, and thenoyl group; oxycarbonyl group such as methoxy carbonyl group, ethoxy carbonyl group, 2-methoxyethoxy carbonyl group, and 4-methoxyphenoxy carbonyl group; carbamoyl group such as carbamoyl group, N,N-dimethylcarbamoyl group, N,N-diethylcarbamoyl group, N-phenyl carbamoyl group, N-[2,4-bis(pentyloxy)phenyl] carbamoyl group, N-[2,4-bis(octyloxy)phenyl] carbamoyl group, and morpholino carbonyl group; alkylsulfonyl group or aryl sulfonyl group such as methane sulfonyl group, benzene sulfonyl group, and toluene sulfonyl group; phosphono group such as diethylphosphono group; heterocyclic group such as benzoxazol-2-yl group, benzothiazol-2-yl group, 3,4-dihydroquinazolin-4-on-2-yl group, and 3,4-dihydroxyquinazolin-4-sulfone-2-yl group; nitro group; imino group; and cyano group.

Further, an electron attracting group represented by E¹ and E² may join to each other to form a ring. As the ring formed with E¹ and E², a 5-membered or 6-membered carbocyclc or heterocyclic ring is preferred.

L in formula (19) represents a group which splits upon azo-coupling, and the splitting group L includes halogen atoms (for example, fluorine, bromine, chlorine and iodine), substituted alkyl groups (for example, hydroxymethyl group, dimethylaminomethyl group), alkylthio group (for example, ethylthio group, 2-carboxyethylthio group, dodecylthio group, 1-carboxydodecylthio group), arylthio group (for example, phenylthio group, and 2-butoxy-t-ocrylphenylthio group), alkoxyl group (for example, ethoxy group, dodecyloxy group, methoxyethylcarbamoylmethoxy group, carboxypropyloxy group, methylsulfonylethoxy group, and ethoxycarbonylmethoxy group), aryloxy group (for example, 4-methylphenoxy group, 4-chlorophenoxy group, 4-methoxyphenoxy group, 4-carboxyphenoxy group, 3-ethoxycarboxyphenoxy group, 3-acetylaminophenoxy group, and 2-carboxyphenoxy group), acyloxy group (for example, acetoxy group, tetradecanoyloxy group, and benzoyloxy group), arylsulfonyloxy group (for example, toluenesulfonyloxy group), dialkylaminocarbonyloxy group (for example, dimethylaminocarbonyloxy group, and diethylaminocarbonyloxy group), diarylaminocarbonyloxy group (for example, diphenylaminocarbonyloxy group), alkoxycarbonyloxy group (for example, ethoxycarbonyloxy group, and benzyloxycarbonyloxy group), aryloxycarbonyloxy group (for example, phenoxycarbonyloxy group), or heterocyclic group (for example, imidazolyl group, pirazolyl group, triazolyl group, and tetrazolyl group).

Specific examples of the coupler represented by formula (19) are to be shown below, but the invention is not restricted to them. Tautomer of the coupler shown below can also be included preferably.

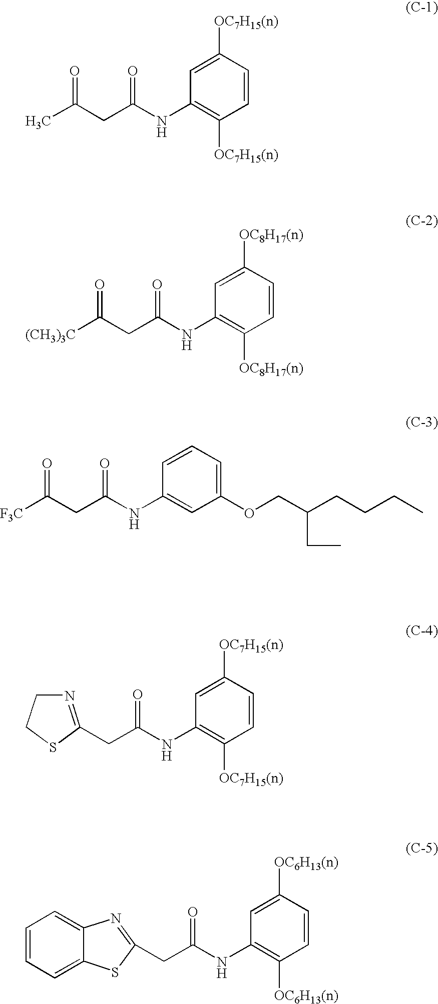

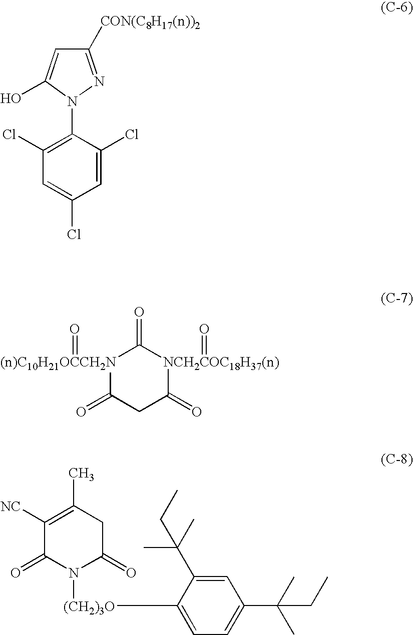

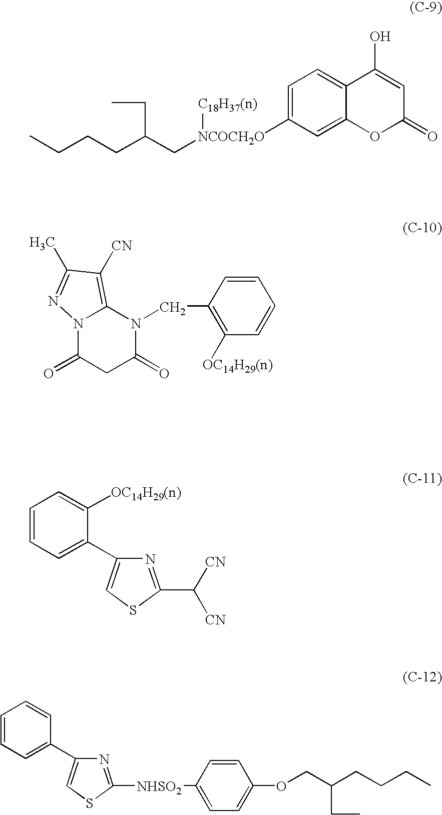

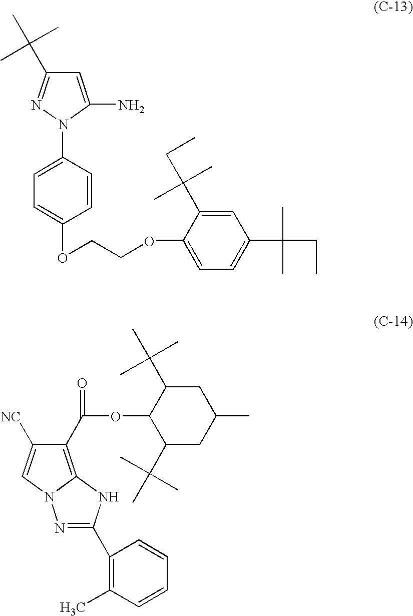

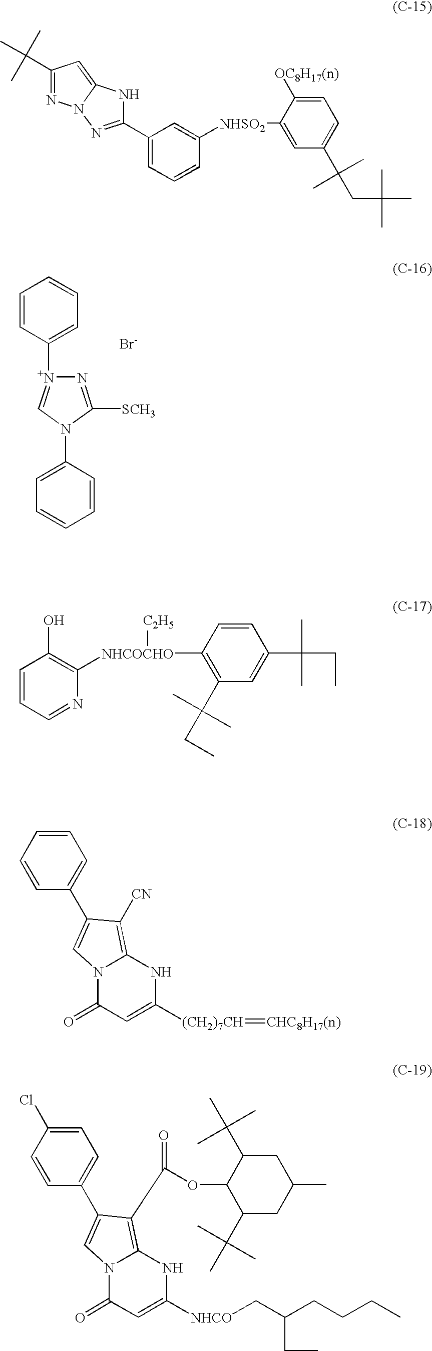

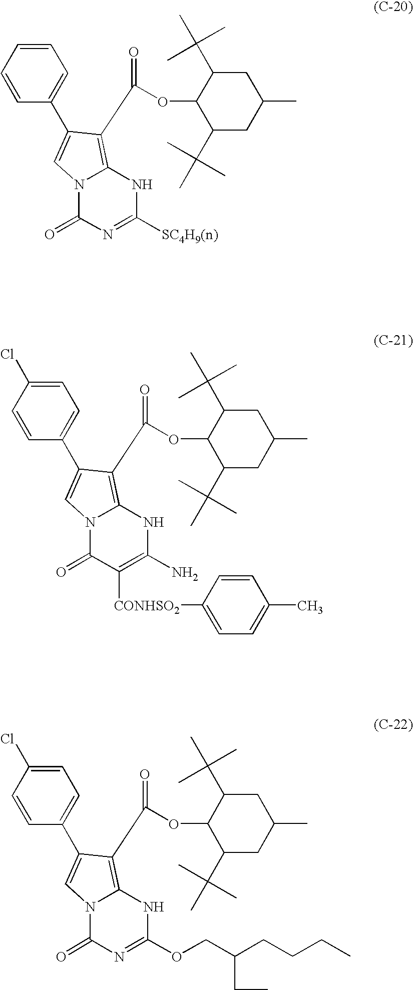

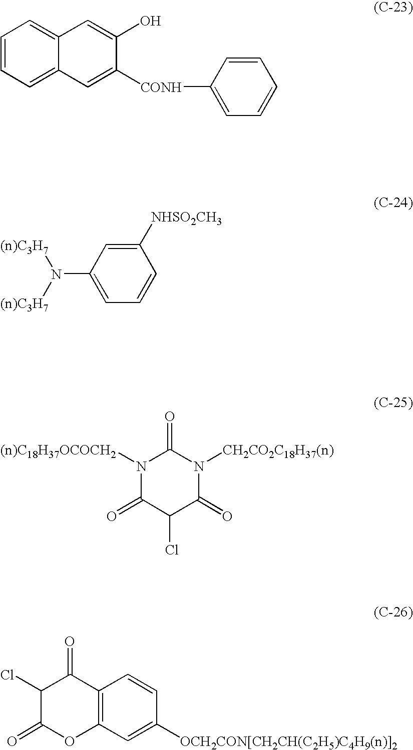

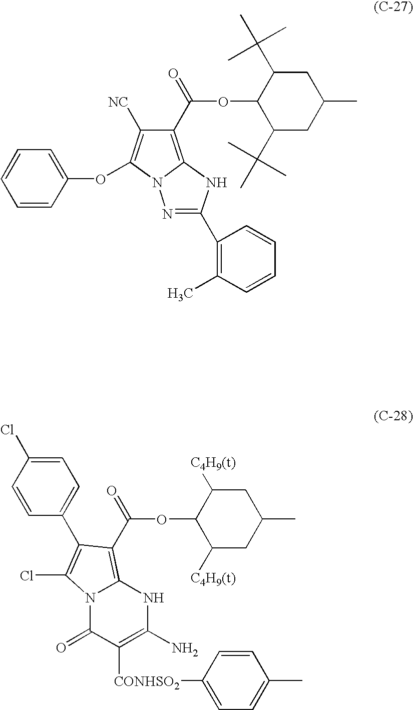

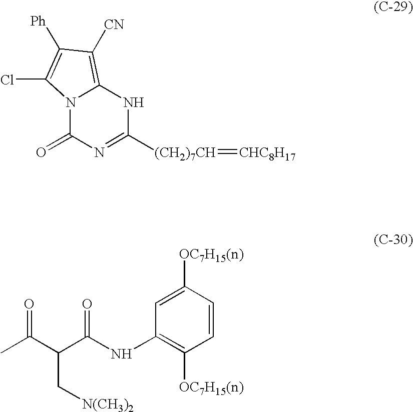

The tautomers of the coupler are present as isomers for the coupler typically represented as described above which are in a relation that structures change easily between each other, and such tautomers are also preferred as the coupler used in the invention.

The coupler may be used singly or two or more the couplers may be used in combination. The content of the coupler in the heat sensitive recording layer is preferably from 0.1 to 30 mass parts based on 1 mass part of the diazonium salt compound.

(Organic Base)

In the heat sensitive recording layer in the invention, an organic base is added preferably with an aim of promoting the coupling reaction between the diazonium salt compound and the coupler.

The organic base is preferably incorporated together with diazonium salt compound and the coupler in the heat sensitive recording layer and the organic base may be used singly or two or more bases may be used in combination.

The organic base includes nitrogen-containing compounds such as tertiary amine, piperidines, piperazines, amidines, formamidines, pyridines, guanidines, and morpholines. Further, those described in JP-B No. 5246806, JP-A Nos. 62-70082, 57-169745, 60-94381, 57-123086, 58-1347901, 6049991, JP-B Nos. 2-24916, 2-28479, JP-A Nos. 60-165288, and 57-185430.

Among them, piperazines such as N,N′-bis(3-phenoxy-2-hydroxypropyl)piperazine, N,N′-bis[3-(p-methylphenoxy)-2-hydroxypropyl]piperazine, N,N′-bis [3-(p-methoxyphenoxy)-2-hydroxypropyl]piperazine, N,N′-bis[3-phenylthio-2-hydroxypropyl)piperazine, N,N′-bis[3-(β-naphthoxy)-2-hydroxypropyl]piperazine, N-3-(β-naphthoxy)-2-hydroxypropyl-N′-methylpiperazine, and 1,4-bis-{[3N-methylpiperazino)-2-hydroxy]propyloxy}benzene, morpholines such as N-[3-(β-naphthoxy)-2-hydroxy]propylmorpholine, 1,4-bis(3-morpholino-2-hydroxy-propyloxy)benzene, and 1,3-bis(3-morpholino-2-hydroxy-propyloxy)benzene, piperidines such as N-(3-phenoxy-2-hydroxypropyl)peperidine, and N-dodecylpiperidine, and guanidines such as triphenylguanidine, tricyclohexyl guanidine, and dicyclohexylphenylguanidine.

The content of the organic base in the heat sensitive recording layer in a case where the organic base is incorporated as required is preferably from 0.1 to 30 mass parts based on 1 mass part of the diazonium salt compound.

(Other Additives)

In the heat sensitive recording material of the invention, other additives such as sensitizer, binder and antioxidant can be incorporated in addition to the ingredients described above.

In the heat sensitive recording material according to the invention, a sensitizer can also be added in the heat sensitive recording layer with an aim of promoting the color forming reaction.

The sensitizer is a substance of increasing the coloring density upon heat recording, or lowering the lowest color forming temperature, which renders the diazonium salt compound, the organic base, coupler, etc. into a readily reacting state by the effect of lowering the melting point of the coupler, the organic base or diazonium salt compound, or lowering the solftening point of capsule walls.

Specifically, an organic compound of low melting point properly having an aromatic group and a polar group in the molecule is preferred and includes, for example, benzyl p-benzyloxy benzoate, α-naphthylbenzyl ether, β-naphtylbenzyl ether, β-naphthoic acid phenyl ester, α-hydroxy-β-naphthoic acid phenyl ester, β-naphthol-(p-chlorobenzyl) ether, 1,4-butanediol phenyl ether, 1,4-butanediol-p-methylphenyl ether, 1,4-butanediol-p-ethylphenyl ether, 1,4-butanediol-m-methylphenyl ether, 1-phenoxy-2-(p-tolyloxy)ethane, 1-phenoxy-2-(p-ethylphenoxy)ethane, 1-phenoxy-2-(p-chlorophenoxy)ethane, and p-benzylbiphenyl.

The binder for use in the heat sensitive recording layer in the invention includes, for example, known water soluble polymeric compounds or latexes.

The water soluble polymeric compounds include, for example, methylcellulose, carboxymethylcellulose, hydroxyethyl cellulose, hydroxypropyl cellulose, starch derivatives, casein, gum Arabic, gelatin, ethylene-maleic acid anhydride copolymer, styrene-maleic anhydride copolymer, polyvinyl alcohol, epichlorhydrine-modified polyamide, isobutylene-maleic salicylic anhydride copolymer, polyacrylic acid, polyacrylic acid amide, etc. and modification products thereof. The latexes include, for example, styrene-butadiene rubber latex, methyl acrylate-butadiene rubber latex, vinyl acetate emulsion.

Further, in the heat sensitive recording layer in the invention, known antioxidants, etc. shown below are also used preferably with an aim of improving the light and heat fastness of colored images or mitigating yellowing by the light in not-printed area (non-image area) after fixing.

The antioxidants can include those described, for example, in EP-A Nos. 223738, 309401, 309402, 310551, 310552, and 459416, GP-A No. 3435443, JP-A Nos. 54-48535, 62-262047, 63-113536, 63-163351, 2-262654, 2-71262, 3-121449, 5-61166, and 5-119449 and USP. Nos. 4814262 and 4980275.

In the invention, the mode of using other ingredients such as the coupler, the organic base and the sensitizer is not particularly restricted and includes, for example, (1) a method of use in solid dispersion, (2) a method of use in emulsifying dispersion, (3) a method of use in polymer dispersion, (4) a method of use in latex dispersion, and (5) a method of utilizing micro-encapsulation.

(Method of Preparing Microcapsule)

The diazonium salt compound used in the invention is preferably incorporated into a microcapsule and, with a view point of effectively preventing formation of photodecomposed stains, it is particularly preferred to incorporate the compound represented by the formula (1) together with the diazonium salt compound in the microcapsule.

For the method of micro-encapsulating the diazonium salt compound and the compound represented by the formula (1), known method can be used and suitably includes, for example, an interface polymerization method of mixing an oil phase prepared by dissolving or dispersing a wall material ingredient a, a diazonium salt compound and a compound represented by the formula (1) all together in a less water soluble or water insoluble organic solvent, and an aqueous phase formed by dissolving a wall material ingredient b and a water soluble polymer, dispersing them under emulsification by a homogenizer or like other means, then conducting a polymer forming reaction of the wall material ingredients a and b at the interface of the oil droplet by heating, thereby forming a microcapsule wall of polymeric material. The interface polymerization method can form capsules of uniform grain size in a short period of time to obtain a recording material of excellent unprocessed stock storability.

The organic solvent includes, for example, low boiling auxiliary solvents such as acetate ester, methylene chloride, and cyclohexanone.

The water soluble polymer includes water soluble polymers such as polyvinyl alcohol and, includes, for example, polyvinyl alcohol, silanol-modified polyvinyl alcohol, carboxy-modified polyvinyl alcohol, amino-modified polyvinyl alcohol, and itaconic acid-modified polyvinyl alcohol, styrene-maleic anhydride copolymer, butadiene-maleic anhydride copolymer, ethylene-maleic anhydride copolymer, isobutylene-maleic anhydride copolymer, polyacrylamide, polystyrene sulfonic acid, polyvinyl pyrrolidine, ethylene-acrylic acid copolymer and gelatin, with the carboxy-modified polyvinyl alcohol being particularly preferred.

For the water soluble polymer, an emulsion or a latex of a hydrophobic polymer, etc. can be used together. The emulsion or latex includes styrene-butadiene copolymer, carboxyl-modified styrene-butadiene copolymer, acrylonitrile-butadiene copolymer, etc. In this case, known surfactant, etc. may also be added optionally.

The polymeric material constituting the microcapsule wall includes, for example, polyurethane resin, polyurea resin, polyamide resin, polyester resin, polycarbonate resin, aminoaldehyde resin, melamine resin, polystyrene resin, styrene-acrylate copolymer resin, styrene-methacrylate copolymer resin, gelatin, and polyvinyl alcohol. Among all, polyurethane/polyurea resin is particularly preferred.

For example, in a case of using the polyurethane/polyurea resin for the capsule wall material, a microcapsule wall can be formed by mixing a microcapsule wall precursor such as a polyvalent isocyanate, etc., in an oil medium (oil phase) to be encapsulated as a core material, further, mixing a second material (for example, polyol, polyamine) that reacts with the microcapsule wall precursor to form a capsule wall in an aqueous water soluble polymer solution (aqueous phase), dispersing under emulsification the oil phase into the aqueous phase and heating them thereby causing a polymer forming reaction at the interface of oil droplets.

Specific examples of the polyvalent isocyanate compound are shown below, but they are not restrictive. They include, for example, diisocyanates such as m-phenylene diisocyanate, p-phenylene diisocyanate, 2,6-tolylene diisocyanate, 2,4-tolylene diisocyanate, naphthalene-1,4-diisocyanate, diphenylmethane-4,4′-diisocyanate, 3,3′-diphenylmethane-4,4′-diisocyanate, xylene-1,4-diisocyanate, 4,4′-diphenylpropane diisocyanate, trimethylene diisocyanate, hexamethylene diisocyanate, propylene-1,2-diisocyanate, butylene-1,2-diisocyanate, cyclohexylene-1,2-diisocyanate, and cyclohexylene-1,4-diisocyanate, triisocyanates such as 4,4′,4″4-triphenylmethane triisocyanate, and toluene-2,4,6-triisocyanate, tetraisocyanates such as 4,4′-dimethylphenylmethane-2,2′,5,5′-tetraisocyanate, isocyanate prepolymers such as adducts of hexamethylene diisocyanate and trimethylol propane, adducts of 2,4-tolylene diisocyanate and trimethylol propane, adducts of xylylene diisocyanate and trimethylol propane, and adducts of tolylene diisocyanate and hexanetriol. Further, two or more kinds of them may be optionally used in combination. Among all, most preferred are those having three or more isocyanate groups in the molecule.

The grain size of the microcapsule is, preferably, from 0.1 to 2.0 μm and, more preferably, from 0.2 to 1.5 μm.

(Leuco Type Color Forming Agent)

In the heat sensitive recording material according to the invention, a full color heat sensitive recording material, for example, is obtained as a constitution of having a plurality of heat sensitive recording layers on a support, in which at least one layer thereof can be constituted as a layer containing a leuco type color forming agent as a color forming ingredient (combination of an electron donating dye precursor and an electron accepting compound).

The electron donating dye precursor includes, for example, triarylmethane series compounds, diphenylmethane series compounds, thiazine series compounds, xanthene series compounds, spiropyrane series compounds, etc. Among all, the triarylmethane series compounds and the xanthene series compounds are particularly preferred in view of high color forming density.

Specifically, the following compounds can be mentioned and they include, for example, 3,3-bis(p-dimethylaminophenyl)-6-dimethylaminophthalide (that is, crystal violet lacton), 3,3-bis(p-dimethylamino)phthalide, 3-(p-dimethylaminophenyl)-3-(1,3-dimethylindol-3-yl) phthalide, 3-(p-diethylaminophenyl)-3-(2-methylindol-3-yl)phthalide, 3-(o-methyl-p-diethylaminophenyl)-32-methylindol-3-yl) phthalide, 4,4′-bis(dimethylamino) benzohydrin benzyl ether, N-halophenyl leuco auramine, N-2,4,5-trichlorophenyl leuco auramine, rhodamine-B-anilino lactam, rhodamine (p-nitroanilino)lactam, rhodamine-Bpchloroanilino)lactom, 2-benzylamino-6-diethylamino fluoran, 2-anilino-6-diethylamino fluorane, 2-anilino-3-methyl-6-diethylamino fluorane, 2-anilino-3-methyl-6-clohexylmethylamino fluorane, 2-anilino-3-methyl-6-isoamylethylamino fluorane, 2-(o-chloroanilino)-6-methylamino fluorane, 2-octylamino-6-diethylamino fluorane, 2-ethoxyethylamino-3-chloro-2-diethylamino fluorane, 2-anilino-3-chloro-6-diethylamino fluorane, benzoyl leuco methylene blue, p-nitrobenzyl leuco methylene blue, 3-methyl-spiro-dinaphtopyrane, 3-ethyl-spiro-dinaphthopyrane, 3,3′-dichloro-spiro-dinaphthopyrane, 3-benzyl spiro-dinaphthopyrane, and 3-propyl-spiro-dibenzopyrane.

The coating amount of the electron donating dye precursor is preferably from 0.1 to 2 g/m² in the heat sensitive recording layer with the same reason as that in the case of the diazonium salt compound described previously. Further, the electron donating dye precursor is preferably micro-encapsulated with the same reason as that in the case of the diazonium salt compound, and the same method as described above can be used for this method.

The electron accepting compound includes, for example, phenol derivatives, salicylic acid derivatives and hydroxy benzoic acid esters and, among all, bisphenols and hydroxy benzoic acid esters are preferred, particularly. Specifically, they include the following compounds.

For example, they include 2,2-bis(phydroxyphenyl) propane (that is, bisphenol A, 4,4′-(p-phenylenediisopropylidene)diphenol (that is, bisphenol P), 2,2-bis(p-hydroxyphenyl)pentane, 2,2-bis(p-hydroxyphenyl)ethane, 2,2-bis(p-hydroxyphenyl)butane, 2,2-bis(4′-hydroxy-3′,5′-dichlorophenyl)propane, 1,1-(p-hydroxyphenyl)cyclohexane, 1.1-(p-hydroxyphenyl)propane, 1,1-(p-hydroxyphenyl)pentane, 1,1-(p-hydroxyphenyl)-2-ethylhexane, 3,5-di((α-methylbenzyl)salicylic acid and polyvalent metal salts thereof, 3,5-di(tert-butyl)salicylic acid and polyvalent metal salts thereof, 3-α,α-dimethylbenzyl salicylic acid and polyvalent metal salts thereof, butyl p-hydroxybenzoate, benzyl p-hydroxybenzoate, 2-ethylhexyl p-hydroxy bezoate, p-phenylphenol, and p-cumylphenol.

The content of the electron accepting compound in the heat sensitive recording layer is preferably from 0.1 to 30 mass parts based on 1 mass part of the electron donating dye precursor.

(Multi-Color Heat Sensitive Recording Material)

Specific constitution of a multi-color heat sensitive recording material is to be described below.

The heat sensitive recording material according to the invention may be either a mono-color heat sensitive recording material having one heat sensitive recording layer on a support, or a multi-color heat sensitive recording material having a heat sensitive recording layer of a layered structure in which a plurality of mono-color recording layers are laminated.

Particularly, in a case of a full color heat sensitive recording layer containing cyan, yellow, and magenta, a heat sensitive recording material preferably includes a constitution in which all of three layers on the support comprise diazo type color forming agent, or a constitution in which a first heat sensitive recording layer near a support comprises a leuco type color forming agent containing an electron donating dye and an electron accepting compound and the second and the third heat sensitive recording layers each comprises a diazo series color forming agent. In the heat sensitive recording material according to the invention, a constitution in which heat sensitive recording layers that form colors of respective hues in the order of forming cyan, magenta, and yellow colors from the side of the support is preferred. Particularly, as the heat sensitive recording layer in the invention containing microcapsules incorporating the compound represented by the formula (1) and the diazonium salt compound, a heat sensitive recording layer that forms the yellow color is most suitable.

The heat sensitive recording material according to the invention may be constituted, for example, in the form shown by the following (a) to (c).

(a) A recording material having recording layers formed by laminating a photo-fixing type recording layer containing a diazonium salt compound with a maximum absorption wavelength of 365±30 nm and a coupler that reacts with the diazonium salt compound to form a color (first recording layer (layer A)), and a photo-fixing type recording layer containing a diazonium salt compound with a maximum absorption wavelength of 445±50 nm and a coupler that reacts with the diazonium salt compound to form a color (second recording layer (layer B)) on a support, in which a light transmittance control layer and a protective layer are optionally disposed on the layer.

(b) A recording material having a recording material having a recording layer formed by laminating a recording layer containing an electron donating dye and an electron accepting compound (first recording layer (layer A)), a photo-fixing type recording layer containing a diazonium salt compound with a maximum absorption wavelength of 365±30 nm and a coupler that reacts with the diazonium salt compound to form a color (second recording layer (layer B)), and a photo-fixing type recording layer containing a diazonium salt compound with a maximum absorption wavelength of 445±50 nm and a coupler that reacts with the diazonium salt compound to form a color (third recording layer (layer C)) in this order on a support, in which a light transmittance control layer and a protective layer are optionally disposed on the layer.

(c) A recording material having a photo-fixing type recording layer containing a diazonium salt compound with a maximum absorption wavelength of 305±30 nm and a coupler that reacts with the diazonium salt compound to form a color (first recording layer (layer A)), a photo-fixing type recording layer containing a diazonium salt compound with a maximum absorption wavelength of 365±30 nm and a coupler that reacts with the diazonium salt compound to form a color (second recording layer (layer B)), and a photo-fixing type recording layer containing a diazonium salt compound with a maximum absorption wavelength of 445±50 nm and a coupler that reacts with the diazonium salt compound to form a color (third recording layer (layer C)) in this order on a support, in which a light transmittance control layer and a protective layer are optionally disposed on the layer.

The multi-color recording method is to be described bellow with reference to (b) or (c) described above.

At first, the third recording layer (layer C) is heated to form a color by the diazonium salt compound and the coupler contained in the layer. Then, a light with the wavelength at the light emission center of 430±30 nm is irradiated to photolytically decompose and fix the unreacted diazonium salt compound contained in the layer C. Then, a sufficient heat to form color by the second recording layer (B) is given to thereby form a color from the diazonium salt compound and the coupler contained in the layer. In this case, while the layer C is also heated intensely at the same time, since the diazonium salt compound was already photolyzed (photo-fixed) and the color forming performance is lost, it does not form color. Further, a light of a wavelength at the emission center of 360±20 nm is irradiated to photolytically decompose and fix the diazonium salt compound contained in the layer B and, finally, a heat sufficient to form a color from the first recording layer (layer A) is applied to form a color. In this case, while the recording layers of the layer C and the layer B are intensely heated simultaneously, since the diazonium salt compound was already decomposed and the color forming performance is lost, they do not form a color.

Further, in a case where all the recording layers (layer A, layer B, and layer C) comprise diazo type recording layers, photo-fixing is necessary after color formation for the layer C and the layer B but the photo-fixing is not always necessary for the layer A where image recording is conducted finally.

The fixing light source used for photo-fixing can be properly selected from known light sources, which include, for example, various fluorescent lamps, xenon lamps, and mercury lamps. Among all, it is preferred to use a light source where the emission spectrum of the light source substantially is identical with the absorption spectrum of the diazonium type, with a view point of photo-fixing at high efficiency.

In the heat sensitive recording material of the invention, an embodiment comprising a light transmittance control layer or a protective layer on the support in addition to one or plural heat sensitive recording layer(s) is preferred.

<Light Transmittance Control Layer>

The light transmittance control layer contains a UV-ray absorbent precursor and, since it does not function as the UV-ray absorbent before irradiation of light at a wavelength in a region necessary for fixing, the layer shows high light transmittance and allows the transmission of the light at the wavelength in the region necessary for fixing sufficiently upon fixing the photofxing type heat sensitive recording layer. In addition, since the transmittance to visible light is also high, it does not hinder the fixing of the heat sensitive recording layer. The UVay absorbent precursor is preferably incorporated in the microcapsule.

Further, the compound contained in the light transmittance control layer includes compounds as described in JP-A No. 9-1928.

The UV-ray absorbent precursor functions as the UV-ray absorbent by reaction with light or heat after completing the irradiation of light at a wavelength in the region necessary for fixing by light irradiation to the heat sensitive recording layer in which most of the light at the wavelength in the region necessary for fixing the UV-ray region is absorbed by the UV-ray absorbent, to lower the transmittance and improve the light fastness of the heat sensitive recording material. Since it has no effect for absorbing the visible light, transmittance of the visible light does not change substantially.

The light transmittance control layer can be provided at least by one layer in the heat sensitive recording material and, most preferably, it is formed between the heat sensitive recording layer and the outermost protective layer. The light transmittance control layer may also be used in common with the protective layer. Characteristics of the light transmittance control layer can optionally be selected in accordance with the characteristics of the heat sensitive recording layer.

The coating solution for forming the light transmittance control layer (coating solution for use in light transmittance control) is obtained by mixing each of the ingredients described above. That is, the layer can be formed by coating the coating solution for the light transmittance control layer by a known coating method, for example, using a bar coater, air knife coater, blade coater, curtain coater, etc. The light transmittance control layer may be coated simultaneously with the heat sensitive recording layer or the like, or it may be coated and formed on the heat sensitive recording layer after, for example, coating the coating solution thereof and then once drying the heat sensitive recording layer.

The dry coating amount of the light transmittance control layer is preferably from 0.8 to 4.0 g/m².

<Protective Layer>

The protective layer contains, together with a binder, a pigment, lubricant, surfactant, dispersant, fluorescence whitener, metal soap, film hardener, UV-ray absorbent, crosslinker, etc.

The binder can be used within a range not deteriorating the barrier property and the operation efficiency by being properly selected, for example, from polyvinyl alcohol, methyl cellulose, carboxymethyl cellulose, hydroxyethyl cellulose, starch, gelatin, gum arabic, casein, styrene-maleic anhydride copolymer hydrolyzates, ethylene-maleic anhydride copolymer hydrolyzates, isobutylene-maleic anhydride copolymer hydrolyzates, modified polyvinyl alcohol, and polyacrylamide.

In addition to those described above, other binders include, for example, synthesis rubber latex, synthesis resin emulsion, etc. including, for example, styrene-butadiene rubber latex, acrylonitrile-butadiene rubber latex, methyl acrylate-butadiene rubber latex, and vinyl acetate emulsion.

The content of the binder is, preferably, from 10 to 500 mass % and, more preferably, from 50 to 400 mass % based on the pigment in the protective layer.

Further, with an aim of further improving the water proofness, it is effective to use a crosslinker and a catalyst for promoting the reaction thereof together, and the crosslinker includes, for example, an epoxy compound, blocked isocyante, vinyl sulfone compound, aldehyde compound, methylol compound, boric acid, caroboxylic anhydride, silane compound, chelate compound, halogenated compound, etc. Those capable of controlling pH of the coating solution for forming the protective layer to 6.0 to 7.5 are preferred. The catalyst includes, for example, known acids and metal salts and those capable of controlling the pH of the coating solution to 6.0 to 7.5 are preferred in the same manner as described above.

As the pigment in the protective layer, all of known organic or inorganic pigments can be used and include, specifically, calcium carbonate, aluminum hydroxide, barium sulfate, titanium oxide, talc, agalmatolite, kaolinite, baked kaolinite, amorphous silica, colloidal silica, urea-formalin resin powder, polyethylene resin powder, benzoguanamine resin powder, etc. They may be used each singly or two or more of them can be used in admixture.

The lubricant preferably includes, for example, zinc stearate, calcium stearate, paraffin wax, and polyethylene wax.

The surfactant is used for forming a uniform protective layer on the heat sensitive recording layer. The surfactant preferably includes, for example, sulfo-succinic acid type alkali metal salts and fluoro-containing surfactants and includes, specifically, sodium salts and ammonium salts, etc. of di-(2-ethylhexyl) sulfosuccinic acid and din-hexyl)sulfosuccinic acid.

The coating solution for forming the protective layer (coating solution for protective layer) is obtained by mixing each of the ingredients described above. Further, a releasing agent, wax, water repellant, etc. may also be added optionally.

The heat sensitive recording material according to the invention may be formed by coating a coating solution for protective layer by a known coating method on the heat sensitive recording layer formed on the support. The known coating method includes, for example, methods of using a bar coater, air knife coater, blade coater, curtain coater, etc.

The protective layer may be coated simultaneously with the heat sensitive recording layer or the light transmittance control layer, or it may be coated and formed on the heat sensitive recording layer after, for example, coating the coating solution thereof and then once drying the heat sensitive recording layer.

The dry coating amount of the protective layer is, preferably, from 0.2 to 7 g/m² and, more preferably, 1 to 4 g/m². In a case where the dry coating amount is less than 0.2 g/m², water proofness can not sometimes be maintained and, on the other hand, if it exceeds 7 g/m², the heat sensitivity is sometimes lowered remarkably. After coating and forming the protective layer, calendering may also be applied optionally.

<Intermediate Layer>

In a case of laminating the heat sensitive recording layers in plurality, it is preferred to form an intermediate layer between each of the heat sensitive recording layers. Like in the case of the protective layer, pigment, lubricant, surfactant, dispersant, fluoresent whitener, metal soap, UV-ray absorbent, etc. may be incorporated further to various kinds of binders in the intermediate layer. As the binder, binders identical with those for the protective layer can be used.

<Support>

The support includes, for example, polyethylene terephthalate (PET), polyethylene naphthalate (PEN), triacetyl cellulose (TAC), paper, plastic resin, laminated paper, synthesis paper, etc. Further, in a case of obtaining a transparent heat sensitive recording material, it is necessary to use a transparent support, and the transparent support includes synthesis polymer films, for example, polyester films such as of polyethylene terephthalate or polybutylene terephthalate, cellulose triacetate films, or polyolefin films such as of polypropylene or polyethylene.

The support may be used singly or may be used being appended to each other.

The thickness of the synthesis polymeric film is, preferably, from 25 to 300 μm and, more preferably, 100 to 250 μm.

The synthesis polymeric film may be colored to an optional hue and the method of coloring the polymeric film includes, for example, a method of kneading a pigment previously into a resin before film formation and then forming it into a film, a method of preparing a coating solution by dissolving a dye into an appropriate solvent, then coating the same on a transparent colorless resin film by a known coating method, for example, a gravure coating method, roller coating method, or wire coating method, and then drying the same. Among all, preferred are those formed by forming a polyester resin such as polyethylene terephthalate or polyethylene naphthalate kneaded with a blue dye into a film and applying thereto a heat resistant treatment, stretching treatment and antistatic treatment.

The heat sensitive recording layer, protective layer, light transmittance control layer, intermediate layer, etc. can be formed on the support by a known coating method such as a blade coating method, air knife coating method, gravure coating method, roll coating method, spray coating method, dip coating method, bar coating method, etc. followed by drying.

### EXAMPLE

The present invention is to be described more specifically by way of examples but the invention is not restricted to the examples. In the following descriptions, “%” and “parts” represent “mass %” and “mass parts” unless otherwise specified.

### Example 1

1) Preparation of an aqueous solution of gelatin phthalide

32 parts of gelatin phthalide (trade name: MGP gelatin, manufactured by Nippi Collagen Co.), 0.9143 parts of 1,2-benzothiazolin-3-on (3.5% methanol solution, manufactured by Daito Chemix Co.), and 367.1 parts of ion exchanged water were mixed, and dissolved at 40° C. to obtain an aqueous solution of gelatin phthalide.

2) Preparation of an Aqueous Solution of Alkali Treated Gelatin

25.5 parts of alkali treated low ion content gelatin (trade name: #750 Gelatin, manufactured by Nitta Gelatin Co.), 0.7286 parts of 1,2-benzothiazolin-3-on (3.5% methanol solution, manufactured by Daito Chemix Co.), 0.153 parts of calcium hydroxide, and 143.6 parts of ion exchanged water were mixed, and dissolved at 50° C. to obtain an aqueous solution of alkali treated gelatin for preparing emulsion.

3) Preparation of a Microcapsule Liquid Incorporated with a Diazonium Salt Compound

To 15.1 parts of ethyl acetate, were added 2.8 parts of the following diazonium salt compound (D), 2.6 parts of diphenyl phthalate, 2.6 parts of phenyl-2-benzoyloxy benzoic acid, and 2.8 parts of the following compound (E) (trade name of products: Light Ester TMP, manufactured by Kyoei Yushi Chemical Co.), 4 parts of the compound (2) described above, and 0.1 parts of calcium dodecyl benzene sulfonate (trade name: Pionin A41C, 70% methanol solution, manufactured by Takemoto Yushi Co.), and heated and dissolved uniformly.

2.5 parts of a mixture of xylilene diisocyanate/trimethylol propane adduct and xylilene diisocyanate/bisphenol A adduct (trade name: Takenate D110N, 50% ethyl acetate solution, manufactured by Mitsui-Takeda Chemical Co.) and 6.8 parts of xylilene diisocyanate/trimethylol propane adduct (trade name: Takenate D110N, 75% methyl acetate solution, manufactured by Mitsui-Takeda Chemical Co.) were added as a capsule wall material to the mixed solution described above, and stirred so as to be homogeneous, to obtain a liquid mixture (V).

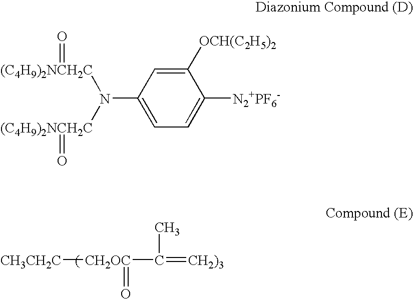

Separately, 21.0 parts of ion exchanged water was added to 55.3 parts of the aqueous solution of gelatin phthalide to obtain a mixed solution (VI).

The mixed solution (V) was added to the mixed solution (VI), and dispersed under emulsification at 40° C. by using a homogenizer (manufactured by Nippon Seiki Seisakusho Co.). After adding 24 parts of water to the obtained liquid emulsion to make it homogenized, capsulating reaction was conducted for three hours by stirring it at 40° C. while removing ethyl acetate.

Then, 4.1 part of an ion exchange resin Amberlite IRA68 (manufactured by Organo Co.) and 8.2 parts of Amberlite IRC50 (manufactured by Organo Co.) were added, and stirred for further one hour. Then, the ion exchanged water was removed by filtration, and the concentration was controlled such that the solid concentration of the capsule liquid was 20%, to obtain a liquid of the diazonium salt compound incorporated microcapsule. The grain size of the obtained microcapsule was 0.43 μm in median diameter as a result of measurement for grain size (measured by La-700, manufactured by Horiba Seisakusho Co.).

4) Preparation of Liquid Coupler Emulsion

To 36.9 parts of ethyl acetate, were dissolved 6.3 parts of the following coupler compound (F), 14.0 parts of triphenyl guanidine (manufactured by Hodogaya Chemical Co.), 14.0 parts of 4,4′-(m-phenylene diisopropylidene) diphenol (trade name: Bisphenol M, manufactured by Mitsui Petrochemical Industries Co.), 14.0 parts of 1,1-(p-hydroxyphenyl)-2-ethyl hexane, 3.5 parts of 3,3,3′,3′-tetramethyl-5,5′,6,6′-tetra(1-propyloxy)-1,1′-spiro-bisindane (manufactured by Sankyo Chemical Co.), 3.5 parts of the following compound (G), 1.7 parts of tricresyl phosphate, 0.8 parts of diethyl maleate, and 4.5 parts of calcium dodecyl benzene sulfonate (trade name: Pionin A-41-C, 70% methanol solution, manufactured by Takemoto Yushi Co.) to obtain a liquid mixture (VII).

Separately, 107.3 parts of ion exchanged water was mixed to 206.3 parts of an aqueous solution of the alkali treated gelatin described above, to obtain a mixed solution (VIII).

The mixed solution (VII) was added to the mixed solution (VIII), and dispersed under emulsification at 40° C. by using a homogenizer (manufactured by Nippon Seiki Seisakusho Co.). The obtained coupler emulsion was heated under reduced pressure to remove ethyl acetate and then the concentration was controlled such that the solid concentration was 24.5%, to obtain a liquid coupler emulsion. The grain size of the obtained coupler emulsion was 0.22 μm in median diameter as a result of measurement for grain size (measured by LA-700, manufactured by Horiba Seisakusho Co.).

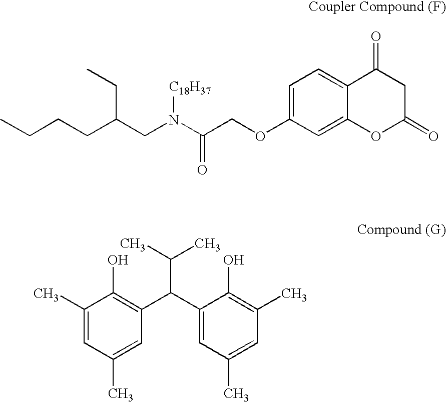

5) Preparation of a Coating Solution for Heat Sensitive Recording Layer

The microcapsule liquid incorporating the diazonium salt compound and the liquid coupler emulsion were mixed such that the mass ratio of the incorporated coupler/diazonium salt compound was 1.9/1. Further, an aqueous solution (5%) of polystyrene sulfonic acid (partially neutralized with potassium hydroxide) was mixed to 10 parts of the capsule liquid so as to be 0.15 parts, to obtain a coating solution for heat sensitive recording layer.

6) Preparation of Coating Solution for Intermediate Layer

100.0 parts of an aqueous solution of alkali treated low ion content gelatin (trade name: #750 Gelatin, manufactured by Nitta Gelatin Co.), 4.8 parts of 1,2-benzothiazolin-3-on (3.5% methanol solution, manufactured by Daito Chemix Co.), 0.3 parts of calcium hydroxide, 6.9 parts of boric acid, and 510.0 parts of ion exchanged water were mixed, and dissolved at 50° C. to obtain an aqueous solution of gelatin for manufacturing intermediate layer.

100 parts of an aqueous solution of gelatin for manufacturing the intermediate layer, 0.5 parts of sodium (4-nonylphenoxytrioxyethylene)butyl sulfonate (2.0% aqueous solution, manufactured by Sankyo Chemical Co.), 0.6 parts of an aqueous solution (5%) of polystyrene sulfonic acid (partially neutralized with potassium hydroxide), 10 parts of an aqueous 4% solution of the following compound (J) (manufactured by Wako Junyaku Co.), 3.3 parts of an aqueous 4% solution of the following compound (J′) and 23 parts of ion exchanged water were mixed to obtain a coating solution for intermediate layer.

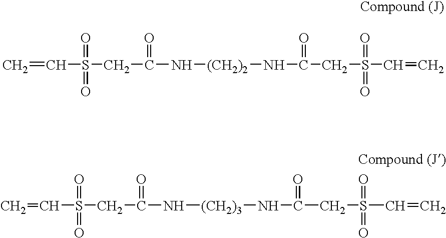

Compound (J)

7) Preparation of Coating Solution for Protective Layer

(Preparation of Polyvinyl Alcohol Solution for Protective Layer)

160 parts of vinyl alcohol—alkyl vinyl ether copolymer (trade name: EP-130, manufactured by Denki Kagaku Kogyo Co.), 8.74 parts of a liquid mixture of sodium alkyl sulfonate and polyoxyethylene alkyl ether phosphate ester (trade name of products: Neoscore CM-57, 54% aqueous solution, manufactured by Toho Chemical Industry Co.) and 3,832 parts of ion exchanged water were mixed, and dissolved at 90° C. for one hour to obtain a homogeneous polyvinyl alcohol solution for protective layer.

(Preparation of Liquid Pigment Dispersion for Protective Layer)

0.2 parts of anionic special polycarboxylic acid type polymer active agent (trade name: Poise 532A, 40% aqueous solution, manufactured by Kao Co.), and 11.8 parts of ion exchanged water were mixed with 8 parts of barium sulfate (trade name: BF-21F, barium sulfate content: 93% or more, manufactured by Sakai Chemical Industry Co.), and dispersed by a Dainomill. As a result of grain size measurement for the liquid dispersion, (measured by LA-910, manufactured by Horiba Seisakusho Co.), it was 0.15 μm or less in median diameter.

8.1 parts of collodal silica (trade name: Snowtex O, 20% aqueous dispersion, manufactured by Nissan Chemical Co.) was added to 45.6 parts of the liquid dispersion, to obtain an aimed liquid pigment dispersion for protective layer.

(Preparation of Matting Agent Liquid Dispersion for Protective Layer)

3.81 parts of aqueous dispersion of 1,2-benz-isothiazolin-3-on (trade name: PROXEL, manufactured by B.D.I.C.I Co.) and 1,976.19 parts of ion exchanged water were homogeneously dispersed in 220 parts of wheat starch (trade name: Wheat Starch S, manufactured by Shinshin Food Industry Co.) to obtain a liquid dispersion of a matting agent for protective layer.

(Preparation of Coating Solution for Protective Layer)

40 parts of surfactant (trade name of products: Megafac F-120, 5% aqueous solution, manufactured by Dainippon Ink Chemical Industry Co.), 50 parts of sodium (4-nonylphenoxytrioxy ethylene)butyl sulfonate (manufactured by Sankyo Chemical Co., 2.0% aqueous solution), 49.87 parts of the liquid pigment dispersion for protective layer, 16.65 parts of the liquid dispersion of matting agent for protective layer, 48.7 parts of a liquid dispersion of zinc stearate (trade name: Hydrin F115, 20.5% aqueous solution, manufactured by Chukyo Yushi Co.), and 280 parts of ion exchanged water were uniformly mixed to 1,000 parts of a polyvinyl alcohol solution for protective layer described above, to obtain a coating solution for protective layer.

8) Preparation of Support with Under Coat Layer (Preparation of coating solution for under coat layer)

40 parts of enzymatically decomposed gelatin (average molecular weight: 10,000, viscosity according to PAGI method: 1.5 mPa·s (15 mP), jelly strength according to PAGI method: 20 g) was added to 60 parts of ion exchanged water and dissolved under stirring at 40° C., to prepare an aqueous gelatin solution for under coat layer.

Separately, after mixing 8 parts of water swellable synthesis mica (aspect ratio: 1,000, trade name: Somashifu ME100, manufactured by Corp Chemical Co.) and 92 parts of water, they were wet dispersed in a Viscomill to obtain a liquid dispersion of mica with an average grain size of 2.0 μm. Water was added to the liquid mica dispersion such that the mica concentration was 5% and mixed uniformly to prepare a desired liquid dispersion of mica.

Then, 120 parts of water and 556 parts of methanol were added to 100 parts of the 40% aqueous gelatin solution for under coat layer at 40° C. and, after sufficiently mixing them under stirring, 208 parts of the 5% liquid dispersion of mica was added and mixed sufficiently under stirring, to which 9.8 parts of 1.66% polyethylene oxide surfactant was added. Then, while keeping the liquid temperature at 35° C. to 40° C., 7.3 parts of a gelatin film hardener of an epoxy compound was added, to prepare a coating solution for under coat layer (5.7%).

(Preparation of Support with Under Coat Layer)

Wood pulp comprising 50 parts of LBPS and 50 parts of LBKP (bleached broad leaf craft pulp) was beaten to a Canadian freeness of 300 ml by a disk refiner, to which were added 0.5 parts of epoxydized behenic acid amide, 1.0 parts of anion polyacrylamide, 1.0 parts of aluminum sulfate, 0.1 parts of polyamide polyamine epichlorohydrin, and 0.5 parts of cation polyacrylamide each by an absolute dry mass ratio based on the pulp and they were made into paper by a fourdrinear machine. Further, a polyvinyl alcohol solution containing calcium chloride and a water soluble fluorescent brightener was coated on both surfaces of base paper by a size press and the base paper having a basis weight of 114 g/m2 was made and controlled to a 100 μm thickness by calendering.

After applying a corona discharging treatment on both surfaces of the base paper, polyethylene was coated by using a melt extruder to a resin thickness of 36 μm to form a resin layer comprising matte surface (the surface is referred to as “rear face”). Then, polyethylene containing 10% anatase type titanium dioxide and a trace amount of ultramarinie blue was coated to a resin thickness of 50 μm on the surface opposite to the rear face where the resin layer was formed by using a melt extruder to form a resin layer comprising a gloss surface (the surface is referred to as “top face”). After applying corona discharging treatment to the polyethylene resin coated surface on the rear face, aluminum oxide (trade name: Alumina Sol 100, manufactured by Nissan Chemical Industry Co.)/silicon dioxide (trade name: Snowtex O, manufactured by Nissan Chemical Industry Co.)=½ (mass ratio) was dispersed as an antistatic agent and coated at a mass of 0.2 g/m2 after drying. Then, after applying a corona discharge treatment to the polyethylene resin coated surface of the top face, the coating solution for the under coat layer was kept at 40° C., coated and dried at 100 mesh by hatched gravure roll, to obtain a support with an undercoat layer. The coating amount before drying of the coating solution for under coat layer was 12.5 g/m2.

9) Formation of Back Layer

(Preparation of Coating Solution for Outermost Back Layer)

To 100 parts of an aqueous 12.5% solution of polyvinyl alcohol (PVA 105, manufactured by Kuraray Co.), were added 6 parts of an aqueous 2% solution of sulfo succinic acid 2-ethylhexyl ester (Rapisol B-90, manufactured by Nippon Yushi Co.), 33 parts of a synthesis liquid mica dispersion (Somashifu MEB-3L, manufactured by Corp Chemical Co.), and 20 parts of a liquid dispersion of aluminum hydroxide (a liquid dispersion formed by mixing 100 parts of Haijilight H42S (manufactured by Showa Light Metal Co.), one part of sodium hexamethaphosphate, and 150 parts of water, and dispersed by a wet dispersion machine such as a ball mill to 0.5 μm average grain size), and stirred to obtain a coating solution for outermost back layer containing synthesis mica, aluminum hydroxide and polyvinyl alcohol.

(Preparation of Coating Solution for Intermediate Back Layer)

300 parts of an aqueous 15% solution of alkali treated gelatin, 100 parts of an aqueous 2% solution of sulfosuccinic acid 2-ethylhexyl ester (Napisol B-90, manufactured by Nippon Yushi Co.) and 1,800 parts of water were mixed, to obtain a coating solution for intermediate back layer.

(Coating of Back Coat Layer)

The coating solution for the intermediate back layer and the coating solution for the outermost back layer were successively coated in this order from the side of the support to the rear face of the support obtained as described above such that each of the coating amount of the solid content after drying was 9.5 g/m2 and 2.2 g/m2 respectively, and dried to form a two-layered back layer comprising the intermediate back layer and the outermost back layer on the support.

10) Formation of Heat Sensitive Recording Layer and Other Layers

The coating solution for heat sensitive recording layer, the coating solution for intermediate layer, and the coating solution for protective layer were simultaneously coated continuously in this order for the three layers to the surface of the under coat layer on the top face of the support, and dried continuously under the conditions at 30° C. and 30% humidity and at 40° C., 30% humidity to obtain the heat sensitive recording material of Example 1.

Coating was conducted such that the coating amount of the diazonium salt compound (D) contained in the solution was 0.206 g/m2 as the coating amount of solid content for the coating solution for heat sensitive recording layer and the coating amount was 2.39 g/m2 as the coating amount of solid content for the coating solution for intermediate layer and the coating amount was 1.39 g/m2 as the coating amount of solid content for the coating solution for protective layer.

### Examples 2 to 8

Heat sensitive recording materials of Examples 2 to 8 were obtained in the same manner as in Example 1 except for changing the compound (2) used in the preparation of the liquid of capsule incorporated with the diazonium salt compound in Example 1 to each of the compounds described in Table 1.

### Comparative Example 1

A heat sensitive recording material of Comparative Example 1 was obtained in the same manner as in Example 1 except for changing 2.6 parts of diphenyl phthalate, 2.6 parts of phenyl-2-benzoyloxy bezoic acid, 2.8 parts of the compound (E), and 4 parts of the compound (2) to 3.9 parts of diphenyl phthalate, 3.9 parts of phenyl-2-benzoyloxy benzoic acid and 4.2 parts of the compound (E) and 0 parts of the compound (2), respectively.

### Example 9

A heat sensitive recording material of Example 9 was obtained in the same manner except for changing 3) preparation of the liquid of capsule incorporated with the diazonium salt compound to that described below and changing the coupler compound (F) in 4) preparation of liquid coupler emulsion to the following coupler compound (I).

3) Preparation of Solution of Microcapsule Incorporated with Diazonium Salt Compound

3.8 parts of a diazonium salt compound (H) described below, 3.8 parts of isopropyl biphenyl, 3.8 parts of the compound (2) described above, 2.0 parts of tricresyl phosphate, 1.1 parts of dibutyl sulfate, 0.38 parts of ethyl 2,4,6-trimethylbenzoylphenyl phosphinate (trade name: Rusirin TPO-L, manufactured by BASF Co.), and 0.07 parts of calcium dodecyl benzene sulfonate (trade name: Pionin A-41C, 70% methanol solution, manufactured by Takemoto Yushi Co.) were added to 12.8 parts of ethyl acetate and heated and dissolved so as to be homogeneous.

10.9 parts of xylylene diisocyanate/trimethylol propane adduct (trade name: Takenate D110N, 75% ethyl acetate solution, manufactured by Mitsui-Takeda Chemical Co.) was added as a capsule wall material to the mixed solution, and stirred so as to be homogeneous, to obtain a liquid mixture (IX).

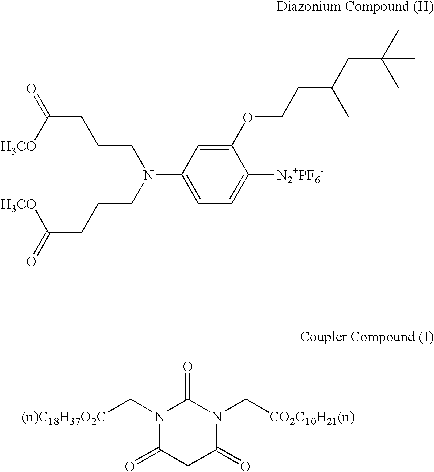

Separately, 22.8 parts of ion exchanged water, and 0.31 parts of an aqueous 25% solution of sodium dodecyl benzene sulfonate (trade name: Neopelex F-25, manufactured by Kao Co.) were added to 59.9 parts of the aqueous solution of gelatin phthalide described above and mixed to obtain a liquid mixture (X).

The liquid mixture (IX) was added to the liquid mixture (X) and dispersed under emulsification at 30° C. by using a homogenizer (manufactured by Nippon Seiki Seisakusho Co.). After adding 29.1 parts of water to the obtained liquid emulsion to homogenize, they were stirred at 40° C. to conduct capsule reaction for 2 hours while removing ethyl acetate. Then, 0.28 parts of 1,2-benzothiazolin-3-on (3.5% methanol solution, manufactured by Daito Chemix Co.) was added.

Then, 1.16 parts of an ion exchange resin Amberlite IRA68 (manufactured by Organo Co.), and 2.33 parts of SWA 100HG (manufactured by Organo Co.) were added and stirred for further 20 min. Then, the ion exchange resin was removed by filtration and the concentration was controlled such that the solid concentration of the capsule liquid was 18.5%, to obtain a liquid of microcapsule incorporated with the diazonium salt compound. As a result of measuring the grain size of the obtained microcapsule was measured (measured by LA-700, manufactured by Horiba Seisakusho Co.), it was 0.57 μm in median diameter.

### Examples 10 to 16

Heat sensitive recording materials of Examples 10 to 16 were obtained by the same method as in Example 9 except for changing the compound (2) used in the preparation of the liquid of capsules incorporated with the diazonium salt compound in Example 9 into each of the compounds described in Table 1 respectively.

### Comparative Example 2

A heat sensitive recording material of Comparative Example 2 was obtained by the same method as in Example 9 except for changing 3.8 parts of isopropyl biphenyl and 3.8 parts of the compound (2) used in the preparation of the liquid of capsule incorporated with the diazonium salt compound in Example 9 to 7.6 part of isopropyl biphenyl and 0 parts of the compound (2).

### Example 17

### Multi-Color Heat Sensitive Recording Material

<Preparation of Gelatin Phthalide Solution>

32 parts of gelatin phthalide (commercial name: #801 Gelatin, manufactured by Nitta Gelatin Co.) and 368 parts of deionized water were mixed and dissolved at 40° C. thus obtaining an aqueous solution of gelatin phthalide.

<Preparation of Alkali Treated Gelatin Solution>

25.5 parts of alkali treated low ion gelatin (commercial name: #750 Gelatin, manufactured by Nitta Geletin Co.), 0.7286 parts of 1,2-benzothiazolin-3-one (3.5% methanol solution, manufactured by Daito Chemics Co.), 0.153 parts of calcium hydroxide, and 143.6 parts of deionized water were mixed and dissolved at 50° C., thus obtaining an aqueous solution of gelatin for preparing an emulsion.

(1) Preparation of Yellow Heat Sensitive Recording Layer Solution

<Preparation of Diazonium Salt Compound-Incorporated Microcapsule Liquid (a)>

0.12 parts of the diazonium compound (K) described below, 0.36 parts of the diazonium compound (L) described below, 1.14 parts of monoisopropyl biphenyl, 0.19 parts of diphenyl phthalate, 0.19 parts of phenyl 2-benzoyloxy benzoate, and 0.05 parts of diphenyl-(2,4,6-trimethylbenzoyl)phosphine oxide (commercial name: Rusilin TPO, manufactured by BASF Japan Co.) were added to 1.92 parts of ethyl acetate, heated at 40° C. and dissolved homogeneously. 0.335 parts xylylene diisocyanate/trimethylol propane adduct (commercial name: Takenate D110N (75 wt % ethyl acetate solution), manufactured by Mitsui-Takeda Chemical Co.). 0.520 parts of a mixture of xylylene diisocyanate/trimethylol propane adduct and xylylene diisocyanate/bisphenol A adduct (commercial name: Takenate D119N (50 wt % ethyl acetate solution), manufactured by Mitsui-Takeda Chemical Co.) were added as capsule wall materials to the liquid mixture described above and homogeneously stirred, thus obtaining a liquid mixture (I).

Separately, 1.26 parts of deionized water and 0.038 parts of Scraph AG-8 (50 wt %), manufactured by Nippon Seika Co.) were added to 6.50 parts of the gelatin phthalide aqueous solution described above, thus obtaining a liquid mixture (II).

The liquid mixture (I) was added to the liquid mixture (II) and dispersed under emulsification at 30° C. by using a homogenizer (manufactured by Nippon Seiki Seisakusho Co.). After adding 2.57 parts of water to the obtained liquid emulsion and homogenizing this, it was stirred at 40° C. and an encapsulating reaction was conducted for three hours while removing ethyl acetate. Then, 0.038 parts of 1,2-benzothiazolin-3-one (3.5% methanol solution, manufactured by Daito Chemics Co.), 0.64 parts of ion exchange resin Amberite SWA100-HG (manufactured by Organo Co.) and 0.32 parts of Amberite IRA67 (manufactured by ROHM AND HAAS (UK) LIMITED) were added and stirred further for 1.5 hours. Then, the ion exchange resins were removed by filtration, and 0.46 parts of an aqueous solution of sodium dodecylbenzene sulfonate ((15 wt %), Neoperex G-15, trade name owned by Kao Corp.) was added.

Then, the concentration was controlled such that the solid concentration of the capsule liquid was 23.0%, thus obtaining a diazonium salt compound-incorporated microcapsule liquid (a). The grain size of the obtained microcapsule (conducted by LA-700 manufactured by Horiba Seisakusho Co.) was measured, and median diameter was found to be 0.46 μm.

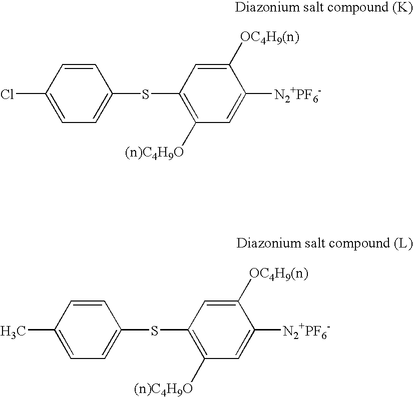

<Preparation of Coupler Compound Liquid Emulsion (a)>

Into 3.67 parts of ethyl acetate were dissolved 1.10 parts of the coupler compound (M) described below, 1.15 parts of triphenyl guanizine (manufactured by Hodogaya Chemical Co.), 2.31 parts of 4,4′-(m-phenylene diisopropylidene)diphenol (commercial name: Bisphenol M (manufactured by Mitsui Chemical Co.)), 0.37 parts of 3,3,3′,3′ tetramethyl-5,5′,6,6′-tetra(1-propyloxy)-1,1′-spirobisindane, 1.51 parts of 4-(2-ethylhexyloxy)benzene sulfonic acid amide, 0.76 parts of 4-n-pentyloxybenzene sulfonic acid amide and 0.47 parts of calcium dodecylbenzene sulfonate (commercial name: Paionin A-41-C, 70% methanol solution, manufactured by Takemoto Oil and Fat Co.) and mixed, thus obtaining a liquid mixture (III).

Separately, 11.29 parts of deionized water was mixed to 22.92 parts of the aqueous solution of alkali treated gelatin, thus obtaining a liquid mixture (IV).

The liquid mixture (III) was added to the liquid mixture (IV) and dispersed under emulsification at 40° C. by using a homogenizer (manufactured by Nippon Seiki Seisakusho Co.). After depressurizing and heating the obtained coupler compound emulsion and removing ethyl acetate, concentration was controlled such that the solid concentration was 26.5% by weight. The grain size of the obtained coupler compound emulsion (conducted by LA-700 manufactured by Horiba Seisakusho Co.) was measured, and the medial diameter was 0.21 μm.

Further, 9 parts of an SBR latex (commercial name: SN-307, 48% liquid, manufactured by Nippon A & L Inc.) controlled to 26.5% concentration was added to 100 parts of the coupler compound emulsion, and stirred homogeneously, thus obtaining a coupler compound liquid emulsion (a).

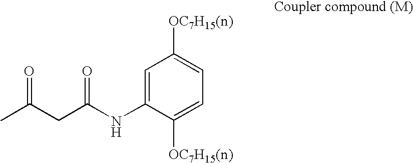

Preparation of Coating Liquid (a)>

The microcapsule encapsulated diazonium salt compound liquid (a) and the coupler compound liquid emulsion (a) were mixed so that the encapsulated coupler compound/diazo compound weight ratio was 2.2/1, thus obtaining a coating liquid (a) for heat sensitive recording layer.

(2) Preparation of Magenta Heat Sensitive Recording Layer Solution

<Preparation of Microcapsule Encapsulated Diazonium Salt Compound Liquid (b)>

Into 1.61 parts of ethyl acetate, 0.495 parts of the diazonium compound (N) described below, 0.60 parts of 4-vinylbenzyl 2-(4-vinylbenzyloxy)benzoate, 0.30 parts of tricresyl phosphate, 0.21 parts of dibutyl sulfate, 0.10 parts of ethyl 2,4,6-ffimethylbenzoyl-phenyl phosphinate ester (commercial name: Rusilin TPO-L, manufactured by BASF Co.), and 0.065 parts of calcium dodecyl benzene sulfonate (commercial name: Paionin A-41-C 10R, 10% methanol solution, manufactured by Takemoto Oil and Fat Co.) were added and dissolved homogeneously by heating. 1.41 parts of xylylene diisocyate/trimethylol propane adduct (commercial name: Takenate D 110N (75 wt % ethyl acetate solution), manufactured by Mitsui-Takeda Chemical Co.) was added as the capsule wall material to the liquid mixture, and stirred homogeneously, thus obtaining a liquid mixture (V).

Separately, 2.96 parts of deionized water and 0.067 parts of 15% aqueous solution of sodium dodecyl benzene sulfonate (commercial name: Neoperex G-15, manufactured by Kao Corp.) were added to 7.77 parts of the aqueous solution of gelatin phthalide and mixed, thus obtaining liquid mixture (VI).

The liquid mixture (V) was added to the liquid mixture (VI), and dispersed under emulsification at 30° C. by using a homogenizer (manufactured by Nippon Seiki Seisakusho Co.). After adding 3.77 parts of water to the obtained liquid emulsion and homogenizing this, it was stirred at 40° C. and an encapsulating reaction was conducted for 2 hours while removing ethyl acetate. Then, 0.035 parts of 1,2-benzothiazolin-3-one (3.5% methanol solution, manufactured by Daito Chemics Co.) was added.

Then, 0.50 parts of Amberite IRA67 (manufactured by Organo Co.), and 1.10 parts of SWA100-HG (manufactured by Organo Co.), which are ion exchange resins, were added and further stirred for 45 min. Then, the ion exchange resins were removed by filtration, and the concentration was controlled such that the solid concentration of the capsule liquid was 17.4%, thus obtaining a microcapsule encapsulated diazonium salt solution (b). The grain size of the obtained microcapsule (conducted by LA-700 manufactured by Horiba Seisakusho Co.) was measured, and the median diameter was 0.59 μm.

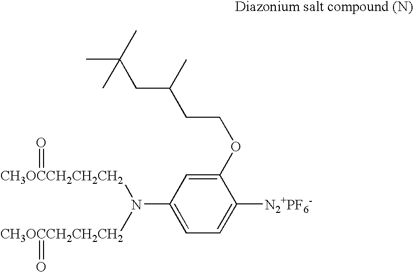

<Preparation of Coupler Compound Liquid Emulsion (b)>

Into 4.10 parts of ethyl acetate, were dissolved 0.70 parts of the following coupler compound (O), 1.56 parts of triphenyl guanizine (manufactured by Hodogaya Chemical Co.), 1.56 parts of 4,4′-m-phenylene diisopropylidene)diphenol (commercial name: bisphenol M (manufactured by Mitsui Chemical Co.)), 1.56 parts of 1,1-(p-hydroxyphenyl)-2-ethylhexane, 0.39 parts of 3,3,3′,3′-tetramethyl-5,5′,6,6′-tetra(1-propyloxy)-1,1′-spirobisindane, 0.39 parts of the compound (P) described below, 0.186 parts of tricresyl phosphate, 0.094 parts of diethyl maleate, and 0.447 parts of calcium dodecylbenzene sulfonate (commercial name: Paionin A-41-C 70% methanol solution, manufactured by Takemoto Oil and Fat Co.), thereby obtaining liquid mixture (VII).

Separately 16.1 parts of deionized water and 0.329 parts of 1,2-benzothiazolin-3-one (3.5% methanol solution, manufactured by Daito Chemics Co.) were mixed with 19.21 parts of the aqueous solution of alkali treated gelatin, thus obtaining a liquid mixture (VIII).

The liquid mixture (VII) was added to the liquid mixture (VIII) and dispersed under emulsification at 40° C. by using a homogenizer (manufactured by Nippon Seiki Seisakusho Co.). After depressurizing and heating the obtained coupler compound emulsion and removing ethyl acetate, the concentration was controlled so that the solid concentration was 24.5% by weight, thus obtaining a coupler compound liquid emulsion (b). The grain size of the obtained coupler compound liquid emulsion was measured (conducted by LA-700 manufactured by Horiba Seisakusho Co.), and the median diameter was 0.26 μm.

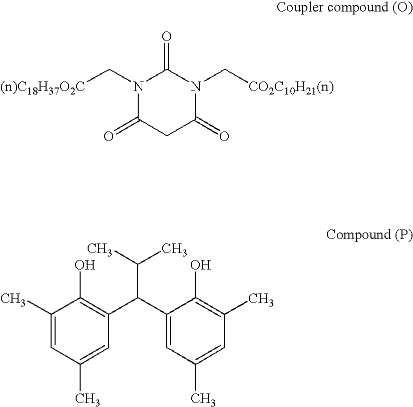

<Preparation of Coating Liquid (b)>

The microcapsule encapsulated diazonium salt liquid (b) and the coupler compound liquid emulsion (b) were mixed so that the incorporated coupler compound/diazo compound weight ratio was 1.9/1. Further, 0.21 parts of an aqueous solution (5 wt %) of polystyrene sulfonic acid (partially neutralized with potassium hydroxide) were mixed relative to 10 parts of the encapsulated liquid, thus obtaining a coating liquid (b) for use in a heat sensitive recording layer.

(3) Preparation of Cyan Heat Sensitive Recording Layer Liquid

<Preparation of Gelatin Phthalide Solution for Microcapsule Liquid (C)>

32 parts of gelatin phthalide (commercial name: #801 Gelatin, manufactured by Nitta Gelatin Co.), 0.9143 parts of 1,2-benzothiazolin-3-one (3.5% methanol solution, manufactured by Daito Chemics Co.), and 367.1 parts of deionized water were mixed and dissolved at 40° C., thus obtaining an aqueous solution of gelatin phthalide.

<Preparation of Microcapsule Encapsulated Liquid with Electron Donating Dye Precursor (c)>

To 20.0 parts of ethyl acetate, were added 7.7 parts of the electron donating dye (Q) described below, 60 parts of rape seed oil for food use, 2.4 parts of trimethylol propane trimethacrylate (commercial name: Light ester TMP, manufactured by Kyoeisha Oils and Fats Chemical Co), 4.9 parts of Irgaperm 2140 (manufactured by Chiba Specialty Chemicals Co.), and 2.7 parts of 1,1,3,3-tris(2-methyl-4-hydroxy-5-t-butylphenyl)butane (commercial name: Adekacruse DH-37, manufactured by Asahi Denka Industry Co,), and heated and dissolved homogeneously. 7.0 parts of xylylene diisocyanate/trimethylol propane adduct (commercial name: Takenate D110N (75 wt % ethyl acetate solution), manufactured by Mitsui-Takeda Chemical Co.), 7.0 parts of polymethylene polyphenyl polyisocyanate (commercial name: Millionate MR-200, Nippon Polyurethane Industry Co.), and 2.3 parts of a mixture (50% ethyl acetate solution) formed by adding 1 mol of the compound (R) described below to 6 mol of xylylene diisocyanate were added as the capsule wall material to the liquid mixture described above and stirred homogeneously, thus obtaining a liquid mixture (IX).

Separately, 10 parts of deionized water, 0.19 parts of Scraph AG-8 (50 wt %, manufactured by Nippon Seika Co.) and 0.42 parts of sodium dodecylbenzene sulfonate (10% aqueous solution) were mixed to 28.8 parts of the aqueous solution of gelatin phthalide and mixed, thus obtaining a liquid mixture (X).

The liquid mixture (IX) was added to the liquid mixture (X) and dispersed under emulsification at 40° C. by using a homogenizer (manufactured by Nippon Seiki Seisakusho Co.). 50.0 parts of water and 0.13 parts of tetraethylene pentamine were added to the obtained liquid emulsion and homogenized, and stirred at 65° C., and an encapsulating reaction was conducted for three hours while removing ethyl acetate, the concentration of the liquid was controlled so that solid concentration was 33%, thus obtaining the microcapsule liquid. The grain size of the obtained microcapsule (conducted by LA-700 manufactured by Horiba Seisakusho Co.) was measured, and the median diameter was 1.13 μm.

3.7 parts of a 15% aqueous solution of sodium dodecylbenzene sulfonate (commercial name: Neoperex G-15, manufactured by Kao Corp.) and 4,4′-bistriazinylaminostylbene-2,2′-disulfone derivative (commercial name: Kaycall BXNL, manufactured by Nippon Soda Co.) were added to 100 parts of the microcapsule liquid described above, and stirred homogeneously, thereby obtaining a microcapsule liquid (c) incorporated with an electron donating colorless dye precursor.

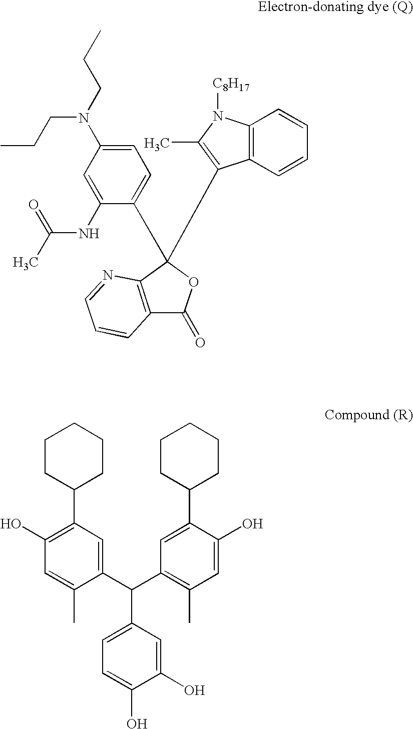

<Preparation of Electron Accepting Compound Dispersion Liquid (c)>

32 parts of gelatin phthalide (commercial name: MGP gelatin, manufactured by Nippi Collagen Co., 0.9143 parts of 1,2-benzothiazolin-3-one (3.5% methanol solution, manufactured by Daito Chemics Co.), and 367.1 parts of deionized water were mixed and dissolved at 40° C., thus obtaining an aqueous solution of gelatin phthalide.

30.1 parts of deionized water, 7.5 parts of 4,4′-p-phenylenediisopropylidene)diphenol (commercial name: Bisphenol P, manufactured by Mitsui Chemical Co.), 7.5 parts of 1,1-bis(4-hydroxyphenyl)-1-phenylethane, 3.8 parts of 2 wt % 2-ethylhexyl sulfosuccinate, and 1.0 part of 2 wt % β-naphthalene sulfonic acid-formalin condensate in aqueous solution of sodium salt (commercial name: Demole NL (manufactured by Kao Corp.)) were added to 8.5 parts of the aqueous solution of gelatin phthalide described above and 11.3 parts of an aqueous 6% solution of PGLE, (commercial name: ML10, manufactured by Daicel Co.), and dispersed over one night by Dainomill, thus obtaining a dispersion liquid. The grain size of the obtained dispersion liquid was measured (by LA-500 manufactured by Horiba Seisakusho Co.), and the median diameter was 0.55 μm.

The solid concentration of the dispersion liquid was adjusted to 26.6 wt %.

31.6 parts of an aqueous solution of the alkali treated gelatin was added to 100 parts of the dispersion liquid described above and, after stirring for 30 min, deionized water was added so that the solid concentration of the dispersion liquid was 23.5%, thus obtaining an electron accepting dispersion liquid (c).

(4) Preparation of Coating Solution for Intermediate Layer

100 parts of alkali treated low ion gelatin (commercial name: #750 Gelatin, manufactured by Nitta Gelatin Co.), 4.8 parts of 1,2-benzothiazolin-3-one (3.5% methanol solution, manufactured by Daito Chemics Co.), 0.3 parts of calcium hydroxide, 6.9 parts of boric acid, and 510 parts of deionized water were mixed and dissolved at 50° C., thus obtaining an aqueous gelatin solution for preparing an intermediate layer.

100 parts of the aqueous gelatin solution for preparing the intermediate layer, 0.5 parts of sodium (4-nonylphenoxytrioxyethylene)butylsulfonate (2.0 wt % aqueous solution, manufactured by Sankyo Chemical Co.), 0.6 parts of an aqueous solution (5 wt %) of polystyrene sulfonic acid (partially neutralized with potassium hydroxide), 10 parts of an aqueous 4 wt % solution of the compound (J) described below (manufactured by Wako Junyaku Co.), 3.3 parts of an aqueous 4 wt % solution of the compound (J′) described below (manufactured by Wako Junyaku Co.), and 23 parts of deionized water were mixed, thus obtaining a coating solution for intermediate layer.

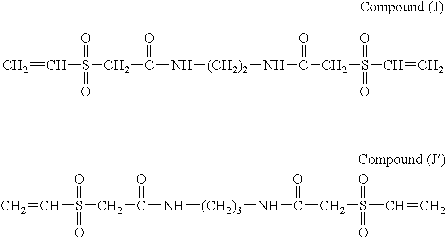

(5) Preparation of Coating Solution for Optical Transmission Control Layer

<Preparation of a Microcapsule Liquid for UV-Ray Absorbent Precursor>

To 2.09 parts of ethyl acetate, were dissolved homogeneously 0.06 parts of [2-allyl-6-(2H-benzotriazol-2-yl)-4-t-octylphenyl]benzene sulfonate, 0.06 parts of (2H-benzotriazol-2-yl)-3-octyloxyphenyl benzene sulfonate, 0.15 parts of 2,4-di-tbutyl-5-chloro-2H-benzotriazol-2-yl)phenyl benzene sulfonate, 0.11 parts of 2-t-butyl-65-chloro-2H-benzotriazol-2-yl)₄-methylphenyl benzene sulfonate, 0.13 parts of 2,5-di-t-octylhydroquinone, 0.05 parts of tricresyl phosphate, 0.15 parts of α-methylstyrene dimer (commercial name: MSD-100, manufactured by Mitsui Chemical Co.), and 0.1 part of calcium dodecylbenzene sulfonate (commercial name: Paionin A-41-C, 70% methanol solution, manufactured by Takemoto Oil and Fat Co.). 0.75 parts of xylylene diisocyanate/trimethylol propane adduct (commercial name: Takenate D110N, 75 wt % ethyl acetate solution, manufactured by Mitsui-Takeda Chemical Co.) was added as a capsule wall material to the liquid mixture described above, and stirred homogeneously, thus obtaining a UV-ray absorbent precursor liquid mixture (XI).

Separately, 0.14 parts of an aqueous 30 wt % solution of phosphoric acid and 13.9 parts of deionized water were mixed with 0.834 parts of itaconic acid modified polyvinyl alcohol (commercial name: KL-318, manufactured by Kuraray Co.) and 0.469 parts of silica modified polyvinyl alcohol (commercial name: R-1130, manufactured by Kuraray Co.), thus preparing an aqueous PVA solution for use in UV-ray absorbent precursor microcapsule liquid.

The UV-ray absorbent precursor liquid mixture (XI) was added to the aqueous PVA solution for use in the UV-ray absorbent precursor microcapsule liquid, and dispersed under emulsification at 20° C. by using a homogenizer (manufactured by Nippon Seiki Seisakusho Co.). After adding 3.1 parts of deionized water to the obtained liquid emulsion and homogenizing, an encapsulating reaction was conducted for three hours under stirring at 40° C. Then, 0.83 parts of ion exchange resin Amberite MB-3 (manufactured by Organo Co.) was added and stirred for one more hour. Then, the ion exchanged resin was removed by filtration and the concentration was controlled so that the solid concentration of the capsule liquid was 13%. The grain size of the obtained microcapsule was measured (by LA-700 manufactured by Horiba Seisakusho Co.), and the median diameter was 0.23±0.05 μm. 41 parts of colloidal silica (commercial name: Snowtex OL (aqueous 20% solution), manufactured by Nissan Chemical Industry Co.) and 4.3 parts of carboxy modified styrene butadiene latex (commercial name: SN-307 (aqueous 48 wt % dispersion), manufactured by Nippon A & L Inc.) were mixed to 1602 parts of the capsule liquid, thus obtaining a microcapsule liquid for UV-ray absorbent precursor.

<Preparation of Coating Solution for Optical Transmittance Adjustment Layer>

296.4 parts of deionized water, 19.5 parts of an aqueous 4 wt % solution of sodium hydroxide, and 51.43 parts of sodium (4-nonylphenoxytrioxyethylene)butyl sulfonate (aqueous 2.0 wt % solution, manufactured by Sankyo Chemical Co.) were mixed to 1,000 parts of the microcapsule liquid for UV-ray absorbent precursor, thus obtaining a coating solution for use in an optical transmittance adjustment layer.

(6) Preparation of Coating Solution for Use in a Protective Layer

<Preparation of Polyvinyl Alcohol Solution for Use in Protective Layer >

150 parts of vinyl alcohol—alkyl vinyl ether copolymer (commercial name: EP-130, manufactured by Denki Kagaku Kogyo Co.), 7.5 parts of a liquid mixture of sodium alkyl sulfonate and polyoxyethylene alkyl ether phosphate ester (commercial name: Neoscoa CM-57 (aqueous 54 wt % solution), manufactured by Toho Chemical Industry Co.), 6.9 parts of acetylenediol ethylene oxide adduct (commercial name: Dinol 604, manufactured by Air Products Japan Co.), 6.9 parts of silicon type surfactant (commercial name: SYLGARD309, manufactured by Toray Dow Corning Silicon Co.), and 3,682 parts of deionized water were mixed and dissolved homogeneously at 90° C. for one hour, thus obtaining a polyvinyl alcohol solution for use in a protective layer.

<Preparation of Pigment Dispersion Liquid for Use in Protective Layer>

0.2 parts of anionic special polycarboxylic acid type polymeric activator (commercial name: Poise 532A, aqueous 40 wt % solution, manufactured by Kao Corp.) and 11.8 parts of deionized water were mixed to 8 parts of barium sulfate (commercial name: BF-21F, barium sulfate content 93% or more, manufactured by Sakai Chemical Industry Co.), and dispersed by a Dainomill, thus obtaining a pigment dispersion liquid for use in a protective layer. The grain size of the dispersion liquid was measured (by LA910 manufactured by Horiba Seisakusho Co.), and the median diameter was 0.15 μm or less.

To 1,000 parts of the liquid barium sulfate dispersion were mixed 3.06 parts of an aqueous dispersion of 1,2-benzoisothiazolin-3-one (commercial name: PROXEL manufactured by B.D.C.I Co.), 36.4 parts of wheat starch (commercial name: Wheat starch S. manufactured by Shinshin Food Industry Co.), 181 parts of colloidal silica (commercial name: Snowtex O (20 wt % aqueous dispersion), manufactured by Nissan Chemical Co.), and 67.7 parts of acryl silicone modified emulsion (commercial name: ARJ-2A, 44 wt % dispersion liquid, manufactured by Nippon Junyaku Co.) were mixed under stirring, thus obtaining the desired dispersion.

<Preparation of Coating Solution for Use in Protective Layer>

To 1,000 parts of the polyvinyl alcohol solution for use in protective layer were mixed homogeneously 90.4 parts of ion exchange water, 49.4 parts of sodium (4-nonylphenoxytrioxyethylene)butyl sulfonate (aqueous 2.0 wt % solution, manufactured by Sankyo Chemical Co.), 87.6 parts of the previously described liquid pigment dispersion for use in the protective layer, 48.2 parts of liquid zinc stearate dispersion (commercial name: Himicron L111, aqueous 21 wt % solution, manufactured by Chukyo Yushi Co.), 153.9 parts of an aqueous 4 wt % solution of the compound (J) described below (manufactured by Wako Junyaku Co.), and 51.3 parts of an aqueous 4 wt % solution of the compound (J′) described below (manufactured by Wako Junyaku Co.), thus obtaining a liquid coating blend for use in a protective layer.

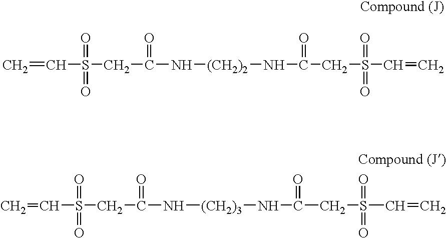

(7) Preparation of Support with Under Coat Layer

<Preparation of Under Coating Layer Solution>

12.85 parts of acetoacetyl modified PVA (polymerization degree: about 1,000, commercial name: Gosefimer-Z-210, manufactured by Nippon Synthesis Chemical Industry Co.) and 87.15 parts of water were added and dissolved under stirring at 90° C. or higher.

While stirring 100 parts of the acetoacetyl modified PVA solution, 2.58 parts of water was added and then 18.90 parts of water swellable liquid synthetic mica dispersion MEB-3 manufactured by Cope Chemical Co. (liquid mica dispersion at aspect ratio of about 1,000, and average grain size of about 2.0 μm) was added and stirred sufficiently. Subsequently, 84.90 parts of methanol was added while stirring gradually and, further, 3.10 parts of 1.66% polyethylene oxide type surfactant dissolved in methanol was added and, finally, 0.45 parts of 1N sodium hydroxide was added, thus obtaining an under coating solution at 6.87%.

<Preparation of Support>

Wood pulp comprising 100 parts of one or more kinds of LBKP (bleached hardwood kraft pulp) was beaten to Canadian Standard Freeness of 300 cc by a disk refiner, to which 0.5 parts of epoxidized behenic acid amide, 1.0 part of anion polyacrylamide, 1.0 parts of alumium sulfate, 0.1 parts of polyamide polyamine epichlorohydrin, and 0.5 parts of cation polyacryl amide were added (all amounts absolute dry weight ratio to the pulp), made into paper by a fourdriner machine. Further, a polyvinyl alcohol solution containing calcium chloride and water soluble fluorescence whitener was coated on both surfaces of the stock paper by a size press to make stock paper of 114 g/m2 basis weight and conditioned to 100 μm thickness by calendering.

Then, after applying a corona discharging treatment on both surfaces of the stock paper, polyethylene was coated to 36 μm thickness by using a melt extruder to form a resin layer having a matte surface (here called the back surface). Then, on the side opposite this resin layer, polyethylene containing 10% by weight of anatase type titanium dioxide and a slight amount of ultramarine was coated, forming a resin layer which has a gloss surface (the top surface). After applying the corona discharging treatment to the polyethylene resin coated back surface, aluminum oxide (commercial name: Aluminasol 100, manufactured by Nissan Chemical Industry Co.)and silicon dioxide (commercial name: Snowtex O, manufactured by Nissan Chemical Industry Co.) at a 1/2 weight ratio was dispersed in water and then coated to be 0.2 g/m2 dry weight on the polyethylene resin coated back surface, serving as the antistatic agent. Then, after applying the corona discharging treatment to the polyethylene resin coated surface at the top surface, the obtained coating solution for under coat layer was kept at a temperature of 40° C. and coated by a hatched gravure roll at 100 mesh and dried. The coating amount before drying was 12.5 g/m2.

(8) Preparation of Back Layer

<Preparation of a Coating Solution for Use in the Outermost Back Layer)

To 100 parts of an aqueous 12.5% solution of polyvinyl alcohol (PVA 105, manufactured by Kuraray Co.), 6 parts of an aqueous 2% solution of 2-ethylhexyl sulfo succinate ester (Rapisol B-90, manufactured by Nippon Yushi Co.), 33 parts of liquid synthetic mica dispersion (commercial name: Somasif MEB-3L, manufactured by Cope Chemical Co.), 100 parts of liquid aluminum dispersion (Higilite H42S (manufactured by Showa Light Metal Co.), one part of sodium hexametaphosphate, and 150 parts of water were mixed, 20 parts of a dispersion liquid dispersed by a wet dispersing machine such as a ball mill (having 0.5±0.1 μm median diameter, found as a result of measuring the grain size by LA-700 manufactured by Horiba Seisakusho Co.) was added and stirred, thus obtaining a coating solution for use in the outermost back layer containing the synthetic mica, aluminum hydroxide and polyvinyl alcohol.

<Preparation of Coating Solution for Use in Intermediate Back Layer>

300 parts of a 15% aqueous solution of alkali treated gelatin, 100 parts of an aqueous 2% solution of 2-ethylhexyl sulfo succinate ester (Rapisol B-90, manufactured by Nippon Yushi Co.), and 1,800 parts of water were mixed, thus obtaining a coating solution for use in an intermediate back layer.

<Coating of Back Coat Layer>

The coating solution for use in the intermediate back layer and the coating solution for use in the outermost back layer were coated from the surface of the above described support opposite to the front surface so that the solid coating amounts after drying were 9.5 g/m2 and 2.2 g/m2, respectively after drying, and then dried to form back coat layers comprising two layers, the intermediate back layer and the outermost back layer, on the support.

<Coating of Coating Solution for Each Heat Sensitive Recording Layer>

On the support to be given the under coat layer is coated the coating solution (c) for the heat sensitive recording layer, the coating solution for the intermediate layer, the coating solution (b) for the heat sensitive recording layer, the coating solution for the intermediate layer, the coating solution (a) for the heat sensitive recording layer, the coating solution for the optical transmittance adjustment layer, and the coating solution for the protective layer in this order from below, continuously in one process for the seven layers, and they were dried at 30° C. and 30% humidity and 40° C. and 30% humidity, thus obtaining multi-color heat sensitive recording materials.

In this case, coating was conducted so that the solid coating amount of the diazo compound (B) contained in the sensitive recording layer coating solution (a) was 0.11 g/m2, and at the same time so that the solid coating amount of the diazo compound (D) contained in the heat sensitive recording layer coating solution (b) was 0.206 g/m2, and so that the solid coating amount of the electron donating dye (F) contained in the heat sensitive recording layer coating solution (c) was 0.355 g/m2.

Further, the coating solution for the intermediate layer was coated so that the solid coating amount of the layer between (a) and (b) was 2.39 g/m2, the solid coating amount of the layer between (b) and (c) was 3.34 g/m2,the solid coating amount in the coating solution for the optical transmittance control layer was 2.35 g/m2, and the solid coating amount of the protective layer was 1.39 g/m2.

### Example 18

Heat sensitive recording material of Example 18 was obtained in the same manner as Example 17 except for changing 4-vinylbenzyl-2-(4-vinylbenzyloxy)benzoate in a magenta capsule in Example 17 into styrene-type oil (compound (21)).

### Example 19

Heat sensitive recording material of Example 19 was obtained in the same manner as Example 17 except for changing the diazonium salt compound in a magenta capsule and the coupler compound in Example 17 into the diazonium salt compound (S) shown below and the coupler compound (F) in Example 1.

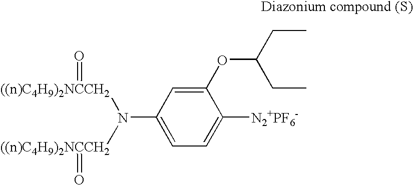

### Example 20

Heat sensitive recording material of Example 20 was obtained in the same manner as Example 19 except for changing 4-vinylbenzyl-2-(4-vinylbenzyloxy)benzoate in a magenta capsule in Example 17 into styrene-type oil (compound (21)).

### Comparative Example 3

Heat sensitive recording material of Comparative Example 3 was obtained in the same manner as Example 17 except for changing 4-vinylbenzyl-24-vinylbenzyloxy)benzoate in a magenta capsule in Example 17 into isopopyl biphenyl.

### Comparative Example 4

Heat sensitive recording material of Comparative Example 4 was obtained in the same manner as Example 19 except for changing 4-vinylbenzyl-2-(4-vinylbenzyloxy)benzoate in a magenta capsule in Example 17 into isopopyl biphenyl.

The obtained heat sensitive recording materials of the examples 1 to 20 and the comparative examples 1 to 4 were exposed to a UV lamp with 420 nm wavelength and 40 W for 10 seconds, and then to a UV lamp with 365 nm wavelength and 40 W for 30 seconds. The images obtained were white.

<<Evaluation>>

The obtained heat sensitive recording materials of the examples and the comparative examples were exposed at 50% humidity to fluorescent lamps at a light illumination of 1,500 lux, and yellow density at the background area of the heat sensitive recording materials at 0 day, 5 days, 15 days, 30 days, and 60 days, after irradiation was measured by X-rite 310TR (manufactured by Nippon Heiban Kizai Co.). This was conducted as a compulsory test relative to the illumination of about 500 lux in daily life. The results are shown in Table 1 and Table 2.

TABLE 1

| | | Irradiation | Irradiation | Irradiation | Irradiation | Irradiation |
|---|---|---|---|---|---|---|
| | Compound | for 0 day | for 5 days | for 15 days | for 30 days | for 60 days |
| Example 1 | (2) | 0.017 | 0.025 | 0.030 | 0.050 | 0.101 |
| Example 2 | (3) | 0.017 | 0.022 | 0.031 | 0.049 | 0.098 |
| Example 3 | (6) | 0.014 | 0.020 | 0.030 | 0.054 | 0.099 |
| Example 4 | (7) | 0.013 | 0.024 | 0.031 | 0.052 | 0.106 |
| Example 5 | (8) | 0.017 | 0.023 | 0.030 | 0.049 | 0.102 |
| Example 6 | (11) | 0.015 | 0.021 | 0.028 | 0.047 | 0.102 |
| Example 7 | (13) | 0.012 | 0.018 | 0.024 | 0.039 | 0.089 |
| Example 8 | (14) | 0.016 | 0.020 | 0.027 | 0.043 | 0.092 |
| Comp. Ex. 1 | — | 0.014 | 0.039 | 0.070 | 0.102 | 0.152 |
| Example 9 | (2) | 0.013 | 0.015 | 0.027 | 0.045 | 0.078 |
| Example 10 | (3) | 0.012 | 0.021 | 0.025 | 0.048 | 0.069 |
| Example 11 | (6) | 0.014 | 0.021 | 0.024 | 0.057 | 0.082 |
| Example 12 | (7) | 0.012 | 0.023 | 0.029 | 0.052 | 0.079 |
| Example 13 | (8) | 0.015 | 0.021 | 0.030 | 0.051 | 0.091 |
| Example 14 | (11) | 0.011 | 0.019 | 0.030 | 0.049 | 0.098 |
| Example 15 | (13) | 0.010 | 0.018 | 0.028 | 0.055 | 0.089 |
| Example 16 | (14) | 0.013 | 0.024 | 0.032 | 0.058 | 0.078 |
| Comp. Ex. 2 | — | 0.012 | 0.037 | 0.062 | 0.089 | 0.124 |

TABLE 2

| | | Irradiation | Irradiation | Irradiation | Irradiation | Irradiation |
|---|---|---|---|---|---|---|
| | Compound | for 0 day | for 5 days | for 15 days | for 30 days | for 60 days |
| Example 17 | 4-vinylbenzyl 2-(4-vinyl | 0.045 | 0.061 | 0.075 | 0.090 | 0.102 |
| | benzyloxy)benzoate | | | | | |
| Example 18 | (21) | 0.047 | 0.063 | 0.078 | 0.093 | 0.100 |
| Comp. Ex. 3 | Isopropyl biphenyl | 0.043 | 0.082 | 0.112 | 0.142 | 0.162 |
| Example 19 | 4-vinylbenzyl 2-(4-vinyl | 0.042 | 0.068 | 0.092 | 0.103 | 0.110 |
| | benzyloxy)benzoate | | | | | |
| Example 20 | (21) | 0.042 | 0.068 | 0.095 | 0.105 | 0.114 |
| Comp. Ex. 4 | Isopropyl biphenyl | 0.040 | 0.095 | 0.132 | 0.160 | 0.174 |

From the results of Table 1 and Table 2, it can be seen that the heat sensitive recording materials of the examples are suppressed from the occurrence of photodecomposed stains in the background area after the compulsory preservation and excellent in the light fastness compared with the heat sensitive recording materials of the comparative examples.

Magenta images were printed to the obtained heat sensitive recording materials by using TRT-21 (manufactured by Nagano Nippon Musen Co.) and a UV-lamp as a printing apparatus, while controlling the printing voltage and the pulse width such that the energy of the thermal head was 9.8 mJ/mm² to 157.2 mJ/mm². Any of the heat sensitive recording materials of Examples 1 to 16 showed sensitivity characteristics approximately equal to those of heat sensitive recording materials of Comparative Examples 1 and 2.

1. A heat sensitive recording material comprising a support and a heat sensitive recording layer containing a diazonium salt compound disposed on the support, wherein a compound represented by formula (1) is contained in the heat sensitive recording material: 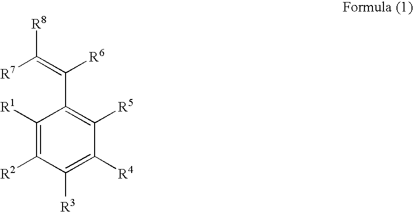
in which R¹ to R⁵ each independently represent a hydrogen atom, halogen atom or a substituted or non-substituted alkyl group, alkenyl group, aryl group, alkoxy group, or aryloxy group; R⁶ to R⁸ each independently represent a hydrogen atom or a substituted or non-substituted alkyl group or aryl group; and R¹ and R⁷, R¹ to R⁵, and R⁶ and R⁸ may join with each other to form a ring, providing that a ring formed by joining of R¹ and R⁷, or R⁶ and R⁸ does not form an aromatic ring.

2. The heat sensitive recording material according to claim 1, wherein the compound represented by formula (1) is contained in the heat sensitive recording layer.

3. The heat sensitive recording material according to claim 1 containing a coupler that reacts with the diazonium salt compound to form a color together with the diazonium salt compound in the heat sensitive recording layer, wherein the diazonium salt compound and the compound represented by formula (1) are incorporated in a microcapsule.

4. The heat sensitive recording material according to claim 1, wherein each of R⁶ to R⁸ in formula (1) is a hydrogen atom.

5. The heat sensitive recording material according to claim 1, wherein at least one of R¹ to R⁵ in formula (1) is a vinyl group.

6. The heat sensitive recording material according to claim 1, wherein at least one of R¹ to R⁵ in formula (1) is a vinyl group, and R⁶ to R⁸ each represent a hydrogen atom.

7. The heat sensitive recording material according to claim 1, wherein a compound selected from following formulae (11) to (15) is contained as the diazonium salt compound: 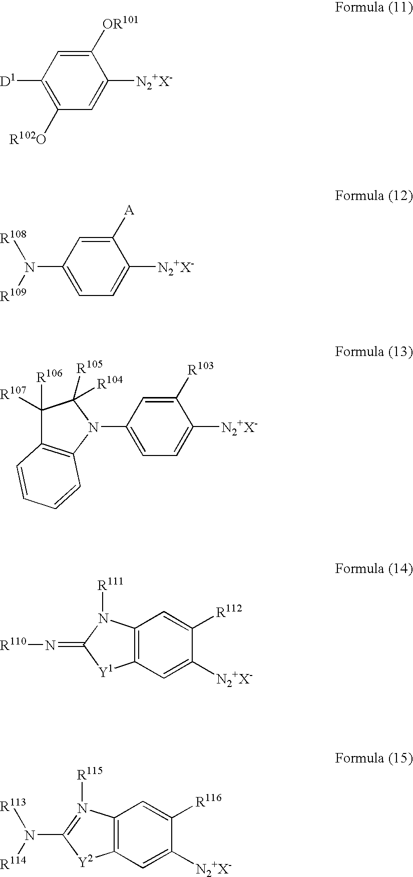
in which R¹⁰¹ and R¹⁰², R¹⁰⁴ to R¹¹¹, and R¹³ to R¹¹⁵ may be identical to or different from each other and each represent a hydrogen atom, alkyl group or aryl group; R¹⁰³, R¹², and R¹¹⁶ each represent a hydrogen atom, alkyl group, alkoxy group, halogen atom, sulfonyl group, acyl group, or alkoxy carbonyl group; D¹ represents an electron donating group with a Hammett's σp value of −0.05 or less, in which a substituted amino group, alkylthio group, arylthio group, alkoxy group, or aryloxy group is preferred; X⁻ represents a counter anion; A represents an electron attracting group with a Hammett's σp value of 0.3 or more; Y¹ and Y² each represent an oxygen atom or sulfur atom, the benzene ring in each of the general formulae (11) to (15) may further have a substituent.

8. The heat sensitive recording material according to claim 1, wherein a compound represented by following formula (16) is contained as the diazonium salt compound: 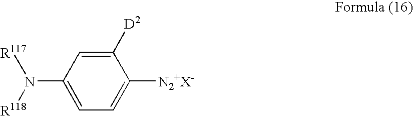
in which R¹¹⁷ and R¹¹⁸ each represent a hydrogen atom, alkyl group, or aryl group; X⁻ represents a counter anion; and D² represents an alkoxy group or aryloxy group.

9. The heat sensitive recording material according to claim 1, wherein a compound selected from following formulae (17) and (18) is contained as the diazonium salt compound: 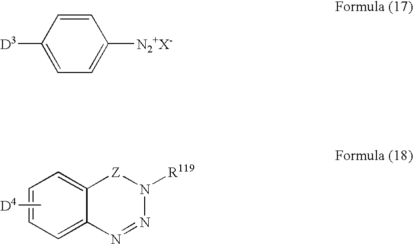
in which D³ and D⁴ in formulae (17) and (18) each represent a group with a Hammett's σp value of −0.45 or more; R¹¹⁹ represents a perfluoro alkyl group, acyl group, or sulfonyl group; X⁻ in formula (17) represents a counter anion; and Z in formula (18) represents —SO₂— or —CO—.

10. The heat sensitive recording material according to claim 1, wherein the material comprises a plurality of the heat sensitive recording layers.

11. The heat sensitive recording material according to claim 10, wherein a diazonium salt compound with a maximum absorption wavelength of 445±50 nm is contained in the heat sensitive recording layer.

12. The heat sensitive recording material according to claim 10, wherein a diazonium salt compound with a maximum absorption wavelength of 365±30 nm is contained in the heat sensitive recording layer.

13. The heat sensitive recording material according to claim 10, wherein a diazonium salt compound with a maximum absorption wavelength of 305±30 nm is contained in the heat sensitive recording layer.

14. A microcapsule containing a diazonium salt compound and the compound represented by formula (1): 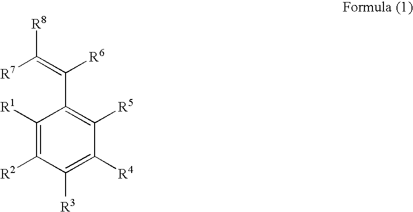
in which R¹ to R⁵ each independently represent a hydrogen atom, halogen atom or a substituted or non-substituted alkyl group, alkenyl group, aryl group, alkoxy group, or aryloxy group; R⁶ to R⁸ each independently represent a hydrogen atom or a substituted or non-substituted alkyl group or aryl group; and R¹ and R⁷, R¹ to R⁵, and R⁶ and R⁸ may join with each other to form a ring, providing that a ring formed by joining of R¹ and R⁷, or R⁶ and R⁸ does not form an aromatic ring.

15. The microcapsule according to claim 14, wherein a compound selected from following formulae (11) to (15) is contained as the diazonium salt compound: 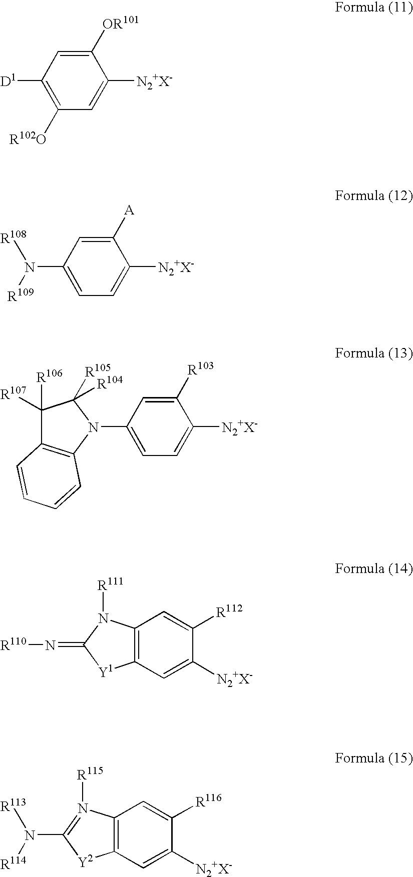
in which R¹⁰¹ and R¹⁰², R¹⁰⁴ to R¹¹¹, and R¹¹³ to R¹¹⁵ may be identical to or different from each other and each represent a hydrogen atom, alkyl group or aryl group; R¹⁰³, R¹¹², and R¹¹⁶ each represent a hydrogen atom, alkyl group, alkoxy group, halogen atom, sulfonyl group, acyl group, or alkoxy carbonyl group; D¹ represents an electron donating group with a Hammett's σp value of −0.05 or less, in which a substituted amino group, alkylthio group, arylthio group, alkoxy group, or aryloxy group is preferred; X⁻ represents a counter anion; A represents an electron attracting group with a Hammett's σp value of 0.3 or more; Y¹ and Y² each represent an oxygen atom or sulfur atom; and the benzene ring in each of the general formulae (11) to (15) may further have a substituent.

16. The microcapsule according to claim 14, wherein a compound represented by following formula (16) is contained as the diazonium salt compound: 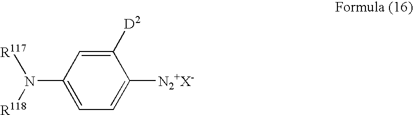
wherein in formula (16), R¹¹⁷ and R¹¹⁸ each represent a hydrogen atom, alkyl group or aryl group; X⁻ represents a counter anion; and D² represents an alkoxy group or aryloxy group.

17. The microcapsule according to claim 14, wherein a compound selected from following formulae (17) and (18) is contained as the diazonium salt compound: 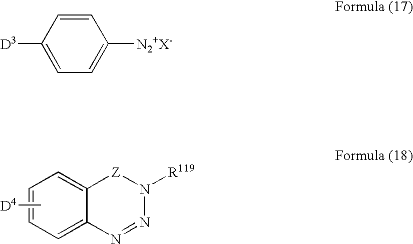
in which D³ and D⁴ each represent a group with a Hammett's σp value of −0.45 or more, and R¹¹⁹ represents a perfluoro alkyl group, acyl group or sulfonyl group in formulae (17) and (18); X⁻ represents a counter anion in formula (17), and Z represents —SO₂— or —CO— in formula (18).
